(19) United States
(12) Patent Application Publication
(10) Pub. No.: US 2011/0022551 A1
(43) Pub. Date: Jan. 27, 2011

(54) METHODS AND SYSTEMS FOR GENERATING SOFTWARE QUALITY INDEX

(76) Inventor: Mark Dixon, Beverly, MA (US)

Correspondence Address: JACOBS & KIM LLP, 1050 WINTER STREET, SUITE 1000, #1082, WALTHAM, MA, 02451-1401, US

(21) Appl. No.: 12/811,754

(22) PCT Filed: Jan. 7, 2009
(86) PCT No.: PCT/US09/30350

§ 371 Date: Sep. 28, 2010

Related U.S. Application Data
(60) Provisional application No. 61/019,750, filed on Jan. 8, 2008.

(51) Int. Cl. G06F 9/44; G06F 15/18

(52) U.S. Cl. 706/12; 717/131

(57) ABSTRACT

Methods, systems and computer program code (software) products for generating a software quality index descriptive of quality of a given body of software code include identifying, by analysis of the body of software code, fault-prone files in the body of software code; constructing and training, by analysis of the body of software code, a model derived from analysis of the body of software code; and generating, based on the model, an index score representative of the quality of the body of software code.

### CROSS-REFERENCE TO RELATED APPLICATIONS

This application for patent claims the benefit of U.S. Provisional Application Ser. No. 61/019,750 filed Jan. 8, 2008 incorporated herein by reference.

### FIELD OF THE INVENTION

The present invention relates generally to systems and methods for software development, and in particular, to systems and methods for monitoring software application quality.

### BACKGROUND OF THE INVENTION

Developing a software product is a difficult, labor-intensive process, typically involving contributions from a number of different individual developers or groups of developers. A critical component of successful software development is quality assurance.

Current enterprise-class software products are typically measured in millions of lines of code. Thus, it is more important than ever to build quality into a software product from the start, rather than trying to track down bugs later. When code quality begins to slip, deadlines are missed, maintenance time increases, and return on investment is lost.

For many companies, the primary desirable quality of source code is that it be correct, i.e., that it have no faults.

At present, software development managers use a number of separate tools for monitoring application quality. These tools include: static code analyzers that examine the source code for well-known errors or deviations from best practices; unit test suites that exercise the code at a low level, verifying that, individual methods produce the expected results; and code coverage tools that monitor test runs, ensuring that all of the code to be tested is actually executed.

These tools are typically code-focused and produce reports showing, for example, which areas of the source code are untested or violate coding standards. The code-focused approach is exemplified, for example, by Clover (www.cenqua.com) and CheckStyle (maven.apache.org/maven-1.x/plugins/checkstyle).

In addition, many software teams use a form of product known as a “version control system” to manage the source code being developed. A version control system provides a central repository that stores the master copy of the code. To work on a source file, a developer uses a “check out” procedure to gain access to the source file through the version control system. Once the necessary changes have been made, the developer uses a “check in” procedure to cause the modified source file to be incorporated into the master copy of the source code. The version control repository typically contains a complete history of the application's source code, identifying which developer is responsible for each and every modification. Version control products, such as CVS (www.nongnu.org/cvs) can therefore produce code listings that attribute each line of code to the developer who last changed it.

Other systems, such as the Apache Maven open-source project (maven.apache.org), claim to integrate the output of different code quality tools. However, while the Apache Maven project appears to provide a way to view the separate reports produced by each tool, it does not appear to integrate them in any way, or provide a software quality index.

Present systems do not provide a simple, meaningful, reliable index of software quality. There exists a need, therefore, for a simple, single, reliable and meaningful metric of source code quality.

While any single metric may inherently omit many aspects of code quality, this is offset by the clarity and simplicity it brings. This offset phenomenon is illustrated in Edward R. Tufte, “Visual Explanations,” pp, 38-53, Graphics Press LLC, 1997 (incorporated herein by reference), which explores the difficulty engineers experienced trying to convince management that it was unsafe to launch the space shuttle Challenger in freezing temperatures. There was existing evidence that the rubber O-rings in the solid-fuel boosters experienced damage at lower launch temperatures, but the damage was classified into four different categories. This separation and classification obscured the relationship between damage and temperature. By combining the damage into a single “damage index” and plotting it against temperature, Tufte clearly highlights the demonstrable excessive risk associated with launch under such conditions. Analogously, in the software environment there are so many metrics that can be collected to describe software quality that it is difficult to derive any actionable information from all the data.

There have been previous attempts to create a single software quality score for a project, but they have been based on an arbitrary combination of factors (e.g., 15% of the score from one factor, 30% from another) with no justification provided for the relative weights, and no indication that the resulting score is a reliable or meaningful indicator of actual software quality.

### SUMMARY OF THE INVENTION

The present invention addresses the deficiencies and improves on the performance of prior art approaches by using an impartial statistical model to weight the various factors, and thereby to generate a reliable, meaningful index of software quality descriptive of quality of a given corpus or body of software code, which can be, for example, an entire software project.

The present invention is based in part on the observation, derived from a large number of source files in one or more software development projects, and faults reported in such files over given periods of time, that some such files will be found to contain a larger than average number of faults, and those files can be categorized as fault-prone files. The invention involves the construction and/or implementation of a statistical model that predicts the probability of a given file being fault-prone, given the values of selected source metrics. This probability is then averaged over an entire project to give a quality score to that project.

One aspect of the invention relates to methods, systems and computer program code (software) products for generating a software quality index descriptive of quality of a given body of software code, wherein the methods, systems and computer program code (software) products include identifying, by analysis of the body of software code, fault-prone files in the body of software code; constructing and training, by analysis of the body of software code, a model derived from analysis of the body of software code; and generating, based on the model, an index score representative of the quality of the body of software code.

In a further aspect of the invention, the identifying of fault-prone files comprises reading details of each checkin between defined analysis start and end dates from a source code control system; if the checkin details for a given file indicate a fault, such as by a comment containing a keyword indicating a fault, incrementing the fault count for each file modified by the checkin; compiling, from the checkin details, a list, of files with their corresponding fault counts; sorting the files in descending order of the number of faults identified; for each file, recording the cumulative number of faults identified; determining the total number of faults defined by the cumulative number recorded against the last file in the list; and reading down the list of files until a point in the list is reached at which the cumulative number of faults reaches a defined percentage of the total number of faults, wherein the files down to that point in the list are defined to be the fault-prone files.

In still a further aspect of the invention, the constructing and training of a model comprises obtaining source code for the start date of a defined analysis range; computing source code metric values and static analysis violation counts for all files in the defined analysis range; identifying the fault prone files within the analysis range; constructing a naive Bayesian model using two categories, fault-prone and non-fault-prone; modeling the static analysis violation counts with a Poisson distribution using the sample mean; modeling the source metrics using the Normal distribution using the sample mean and variance; and if more than one training project is available, testing by training on all but one of the training projects and measuring the classification error on the remaining one.

In a further aspect of the invention, the generating of an index score representative of the quality of the body of software code comprises: computing, source code metric values and static analysis violation counts for all files in the body of software code; submitting each file individually to the naive Bayesian model to compute a predicted probability that the file is fault-prone; converting the probability to an index score using the formula:

score=10(1−prob(fault-prone));

computing an index score for a directory of source files by taking the arithmetic mean (simple average) of the scores of all files in the directory and any subdirectories; and computing an index score for the body of software code by taking the arithmetic mean of the scores of all files in the body of software code.

As discussed herein, the invention can also be embodied as a subsystem, deployable in a software code development system, wherein the subsystem is operable to generate a software quality index descriptive of quality of a given body of software code, and wherein the subsystem comprises means for identifying, by analysis of the body of software code, fault-prone files in the body of software code; means for constructing and training, by analysis of the body of software code, a model derived from analysis of the body of software code; and means for generating, based on the model, an index score representative of the quality of the body of software code.

Also as discussed herein, the invention can be embodied as a computer program code product for use in a computer in a software code development system, the computer program code product being operable to enable the computer to generate a software quality index descriptive of quality of a given body of software code under development, the computer program code product comprising computer-executable program code stored on a computer-readable medium, and the computer program code further comprising: first computer program code means stored on the computer-readable medium and executable by the computer to enable the computer to identify, by analysis of the body of software code under development, fault-prone files in the body of software code under development; second computer program code means stored on the computer-readable medium and executable by the computer to enable the computer to construct and train, by analysis of the body of software code under development, a model derived from analysis of the body of software code under development; and third computer program code means stored on the computer-readable medium and executable by the computer to enable the computer to generate, based on the model, an index score representative of the quality of the body of software code under development.

The following discussion, together with the drawings, provides a detailed description of methods, systems and computer software code products in accordance with the present invention.

### BRIEF DESCRIPTION OF THE DRAWINGS

FIG. 1 is a table setting forth the history of 12 open-source Java projects.

FIG. 2 is a chart setting forth the probability distributions for fault-prone and non-fault-prone files, with respect to the SIZE metric.

FIGS. 3 and 4 are tables setting forth, respectively, the most effective predictors with respect to source metrics and analyzer metrics.

FIGS. 5-7 are flowcharts of exemplary methods, in accordance with one practice of the invention, for identifying fault-prone files, building/training the model and computing the index score for a project, respectively.

FIG. 8 is a schematic block diagram of processing modules according to one embodiment of the invention.

FIGS. 9 and 10 are diagrams illustrating a typical computing environment which aspects of the present invention may be implemented.

FIGS. 11-27 are a series of screenshots illustrating a browser-based implementation of aspects of the present invention.

### DETAILED DESCRIPTION OF THE INVENTION

The present invention provides methods, systems and computer software code products for computing a software quality index for a corpus or body of software code, such as software source code. The invention's techniques for calculating the index are based on a statistical analysis of exemplary source code metrics that have, based on an analysis of data, proven to be reliable indicators of software faults.

The present invention provides thus improved techniques usable in systems for software development, and in particular, in systems and methods for monitoring, software application quality. The following discussion describes methods, structures, systems and computer software code products in accordance with these techniques, and is organized into the following sections:
1. Description of Method Aspects of the Invention
   1.1 introduction
   1.2 Code Quality
   1.3 Training Data
   1.4 Classification Model
   1.5 Results
   1.6 Overall Methods
2. Typical Computing Environments in Which the Invention May Be Implemented
3. Description of an Exemplary Computer Software Code Product in Which the Invention Can Be Implemented
   3.1 Introduction to the Enerjy Software Eclipse Plug-in
   3.2 Downloading and Installing Enerjy Software
   3.3 Enerjy Configuration Wizard
   3.4 Manual Configuration
   3.5 Interpreting Results
   3.6 Troubleshooting
4. Examples of Static Analysis Violations in an Online or Other Practice of the Invention
Examples of DEFS in an Online or Other Practice of the Invention

### 1. Description of Method Aspects of the Invention

1.1 Introduction

The systems and techniques described herein addresses two issues: first, the need for a simple, single metric of source code quality; second, the need for hard evidence with respect to the benefits of source code metrics, such as size and complexity, and static analysis. While many organizations have coding standards, those standards are often somewhat arbitrary and often fall into disuse. Proponents of various standards typically have no specific arguments to justify the perceived overhead that these standards impose on the development process.

In contrast, the present invention is based on a historical analysis of a large body of source code to determine a statistical relationship between certain source code metrics and code quality. With this analysis in place, the statistical model is then used to assign a quality score to any source file.

In the following discussion, those skilled in the art will appreciate that the various examples, embodiments and practices of the invention set forth are provided by way of example, and not by way of limitation; and that numerous modifications, additions, subtractions and other practices of the invention are possible, and are within the spirit and scope of the present invention.

1.2 Code Quality

An initial task is to define what is meant by the term “code quality.” The present description of the invention follows the example of Denaro and Pezze, “An Empirical Evaluation of Fault-Proneness Models,” Proc. International Conf. on Software Engineering (ICSE2002), Miami, USA, (May 2002), incorporated herein by reference, in that the definition of “code quality” is based on the concept of “fault-proneness.”

For most organizations, the ultimate requirement for a source file is that it contains code that functions correctly. While there are other desirable characteristics, in particular, minimizing cost of maintenance, correctness is generally the primary driver. There is also very little data available on the maintenance cost of individual source files, making it very difficult to perform any analysis. Most projects, however, use a source code control system that describes the reason for every code change. This makes it straightforward to identify which files contained faults requiring, a code change to fix.

A fault-prone file is one that contains a disproportionate number of faults. More specifically, this is based on determining, for each file, how many faults were fixed in that file over a given time period. After ranking the files in descending order of the number of faults, the fault-prone files are the files at the top of the list that together account for a predetermined proportion of the total number of faults. Assuming that there exists a method (see discussion below) to determine the probability that a source file is fault-prone, it is possible to define a code quality score using the following formula:

Score=10*[1−Probability(file is fault-prone)]

In accordance with the invention, the score is scaled to run from 0 to 10, with files that have a very high likelihood of being fault-prone scoring near 0 and files that are ver unlikely to be fault-prone scoring near 10.

Given a quality score for a file, the score for a package or project is then defined to be the mean (i.e., average) of all of the contained files. In practice, the score for a file is usually 0 or 10, and rarely falls in between. Thus, the score for a project can be thought of as representing the proportion of fault-prone files within that project.

The following discussion describes a process, in accordance with the present invention, for predicting the probability that a given file is fault-prone.

1.3 Training Data

Classifying a collection of objects into categories based on their attributes is a common problem in data mining. A typical example is a spam filter that attempts to classify documents into spam and non-spam based on the content of the documents. In the present case, it is necessary to classify source files into “fault-prone” and “non-fault-prone” categories based on the values of a number of source code metrics. Being able to construct such a classifier has two benefits. First, most classifiers actually predict a probability that a file is fault-prone rather than an absolute yes/no answer. That probability is exactly what is needed for the quality score. Second, the classifier will identify which metrics are effective predictors of fault-proneness.

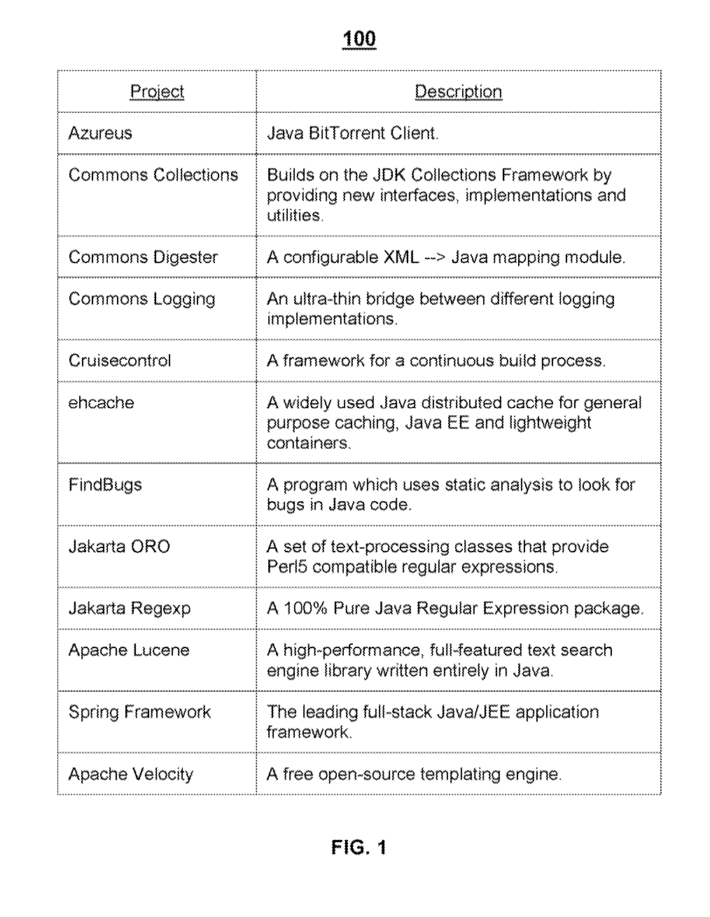

Classifiers typically require a body of training data. Accordingly, the complete history of 12 popular, open-source Java projects has been collected. The projects were as set forth in the table 100, shown in FIG. 1.

For each project, faults were identified by searching the source code control system's history for check-in comments containing the words bug or fix. A manual check on a sample of the projects showed that, while this very crude approach did tend to overcount faults, the error was less than 5%. For each check-in that fixed a fault, the fault count was incremented by 1 for every file that was changed in that check-in. The final data set contained 3817 files, of which 420 (11%) were classified as fault-prone.

Additionally, for each file a total of 228 source metrics were collected, 33 metrics were general source metrics, such as the size of the source file, the number of lines of code and classic McCabe and Halstead complexity measures. The remaining 195 were the number of violations recorded for each of the coding standards defined by the Enerjy Code Analyzer (commercially available from Enerjy Software/TeamStudio, Inc. of Beverly, Mass.). Very similar results would be achieved using a different analyzer, such as Checkstyle, PMD or FindBugs.

1.4 Classification Model

There are several approaches to the classification problem. An overview of approaches is provided in Witten and Frank, “Data Mining—Practical Machine Learning Tools and Techniques,” Morgan Kaufman, 2005, incorporated herein by reference. Another discussion is set forth in Hastie et al., “The Elements of Statistical Learning,” Springer, 2001, incorporated herein by reference. It is noted that Denaro and Pezze (see above) purport to have used a logistic regression model to predict fault-proneness based on a selection of up to five of the source metrics. However. Applicant was unable to replicate their purported success with such a model; instead, a naive Bayesian model was used.

The general approach behind a naive Bayesian model is to assume that all of the metrics are independent, and model each metric separately for fault-prone files and non-fault-prone files. Bayes theorem then provides a formula to combine the information from each metric into an overall probability that a file is fault-prone.

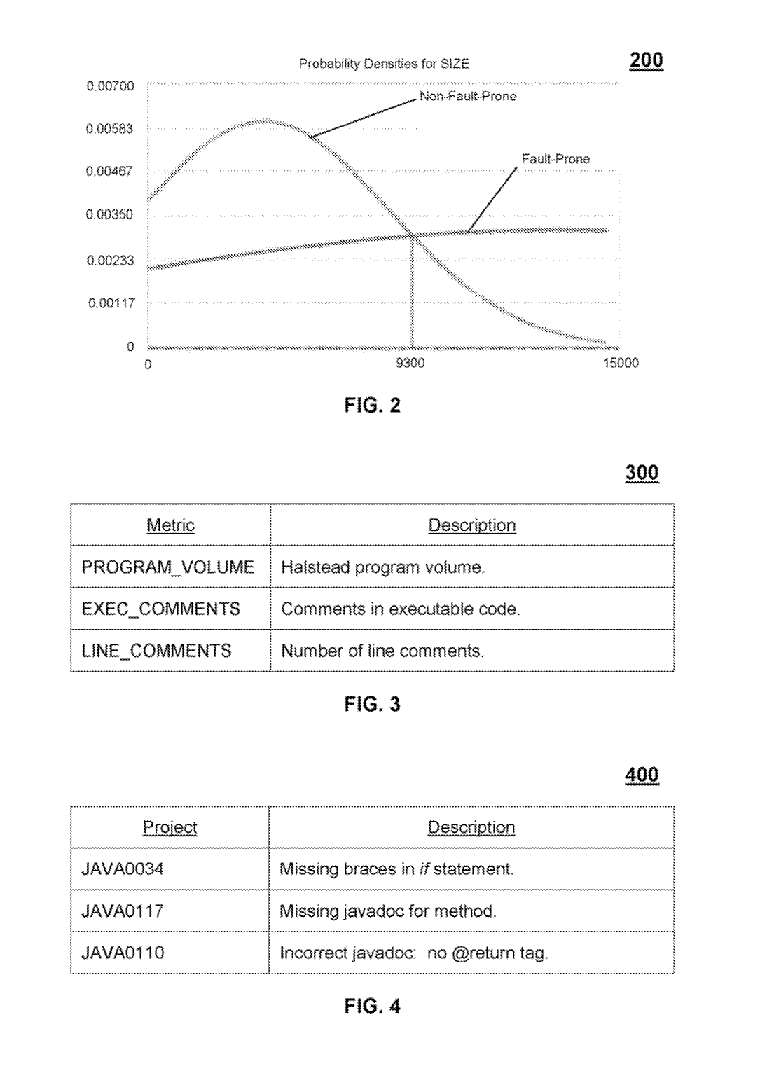

To examine a specific example, the SIZE metric was considered, which is simply the number of characters in the source file. It was decided to model all source metrics using a Normal distribution and all Analyzer violation metrics using a Poisson distribution. For the described training data, it was found that the SIZE metric had an average value of 14,461 characters in fault-prone files but only 4,074 in non-fault-prone files. The attached FIG. 2 is a chart 200 setting forth the probability distributions for both types of file.

Intuitively, the chart 200 of FIG. 2 shows that small files are more likely to be non-fault-prone. This continues until the file size reaches around 9,300 characters, at which point it becomes more likely that the file is fault-prone. Bayes Theorem provides a way to formalize this intuition, and additionally to combine the results for multiple metrics.

1.5 Results

The primary result is that it was possible to generate a model that was an effective predictor of fault-proneness. For 11 of the 12 projects, the model predicted fault-proneness with a classification error rate of around 1.5%. For the remaining project (Velocity) the error rate was around 25%.

Secondly, the assumptions behind the Bayesian model were tested using a Lilliefors test for the normally distributed metrics and a standard chi-squared test for the Poisson distributed metrics. The distributions were found to be a reasonable fit at a 95% confidence level for many of the metrics.

Among the source metrics, the most effective predictors were as shown in the table 300 set forth in FIG. 3. Among the analyzer metrics, the most effective predictors were as shown in the table 400 set forth in FIG. 4.

In all cases, larger values of the metrics indicate fault-proneness. Some of the analyzer metrics were not useful predictors simply because they did not occur in the training data. A richer set of training data should lead to an even better model. It is noted that the Applicant ran the model on a number of open-source projects and the results generally matched the Applicant's expectations, with projects known for their quality scoring high, and others scoring lower.

This work can be expanded in various directions. Among others, it is noted that the current model uses absolute metrics, which are all somewhat influenced by the file's size. Thus, one could construct a model that uses metrics scaled by the file size (i.e., number of violations per line of code rather than just number of violations), and the Applicant has tested such models as well.

1.6 Overall Methods in Accordance with the Invention

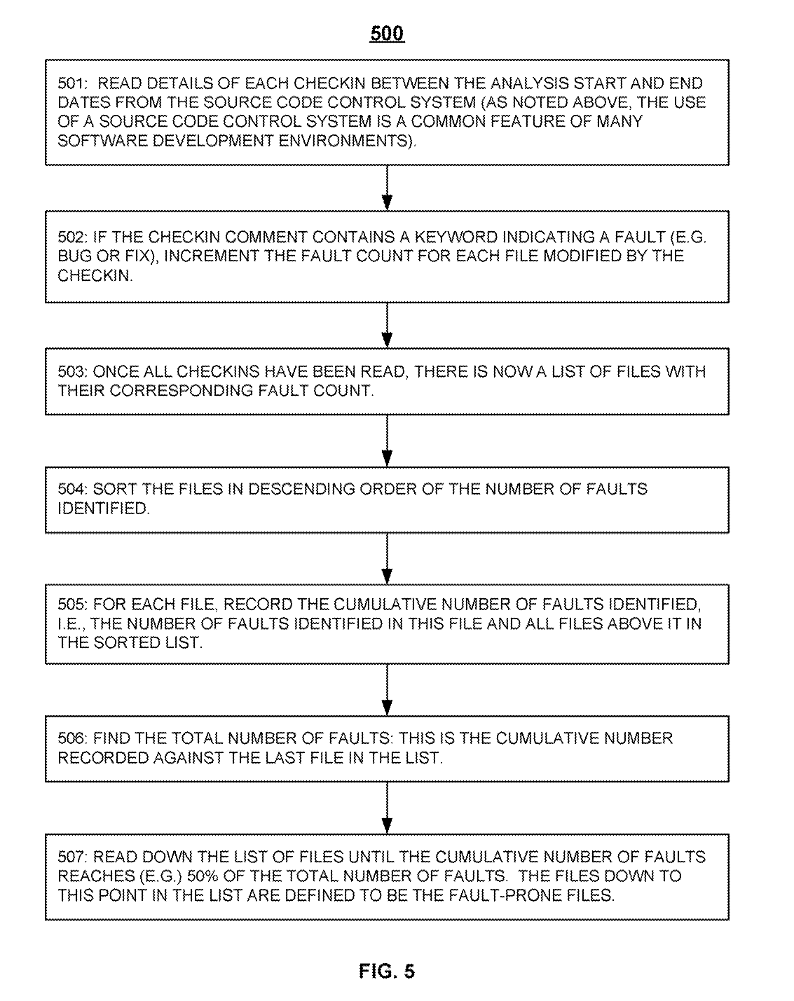

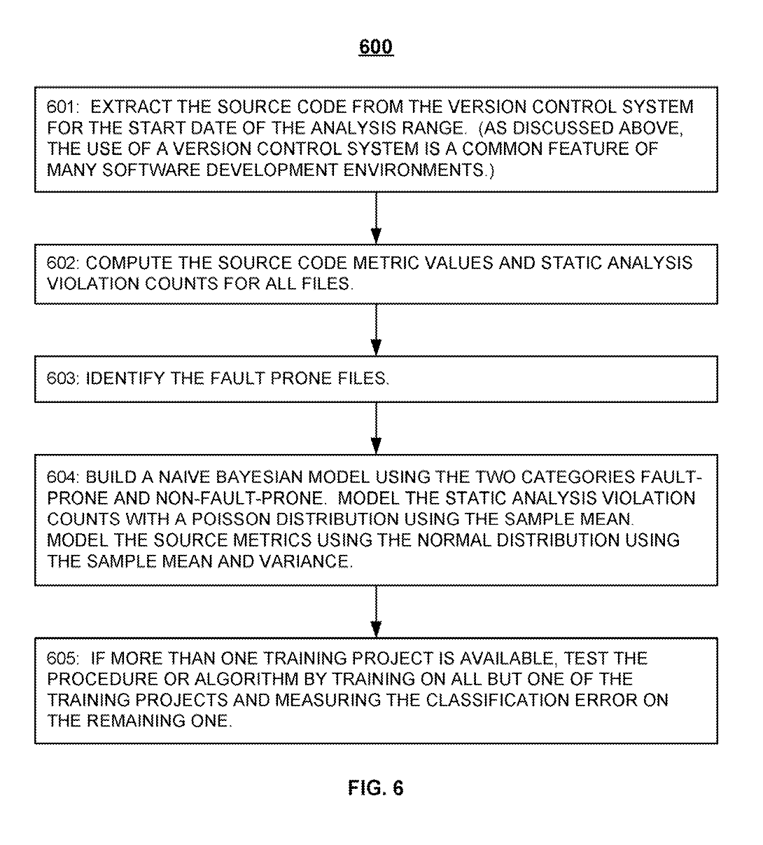

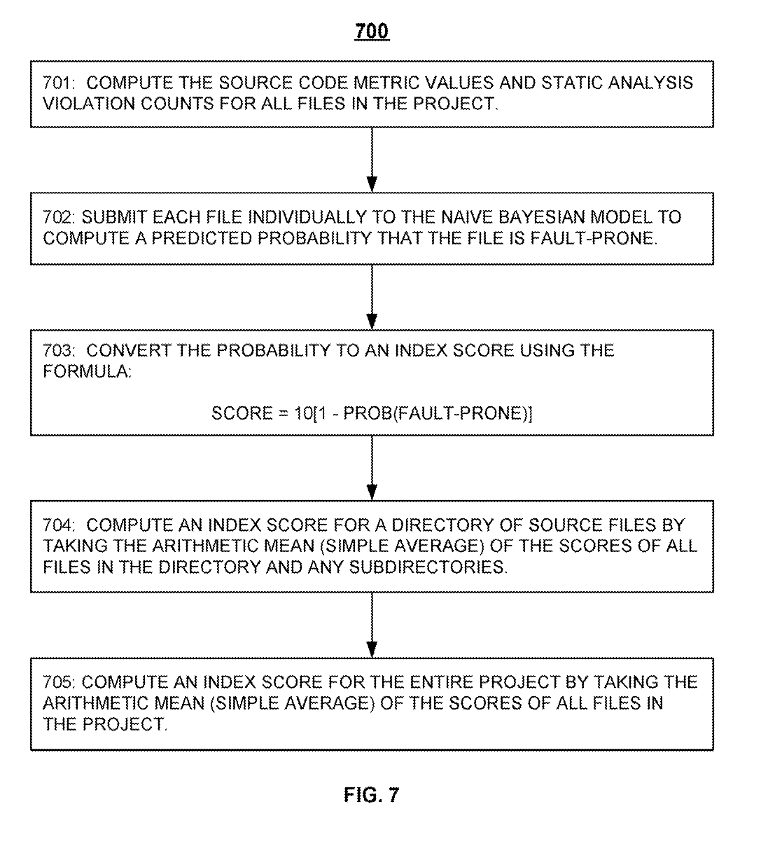

Referring now to FIGS. 5, 6, and 7, the noted drawings are flowcharts of exemplary methods, in accordance with one practice of the invention, for identifying fault-prone files (FIG. 5), building/training the model (FIG. 6) and computing the index score for a project (FIG. 7), respectively.

As shown in FIG. 5 and also as discussed above, a method 500 of identifying fault-prone files in accordance with the present invention comprises the following:

501: Read details of each checkin between the analysis start and end dates from the source code control system (as noted above, the use of a source code control system is a common feature of many software development environments).

502: If the checkin comment contains a keyword indicating a fault (e.g. bug or fix), increment the fault count for each file modified by the checkin.

503: Once all checkins have been read, there is now a list of files with their corresponding fault count.

504: Sort the files in descending order of the number of faults identified.

505: For each file, record the cumulative number of faults identified, i.e., the number of faults identified in this file and all files above it in the sorted list.

506: Find the total number of faults: this is the cumulative number recorded against the last file in the list.

507: Read down the list of files until the cumulative number of faults reaches (e.g.) 50% of the total number of faults. The files down to this point in the list are defined to be the fault-prone files.

As shown in FIG. 6 and also as discussed above, a method 600 of building/training the model in accordance with the present invention comprises the following:

601: Extract the source code from the version control system for the start date of the analysis range. (As discussed above, the use of a version control system is a common feature of many software development environments.)

602: Compute the source code metric values and static analysis violation counts for all files.

603: Identify the fault prone files—see corresponding flowchart FIG. 5 as discussed above.

604: Build a naive Bayesian model using the two categories fault-prone and non-fault-prone. Model the static analysis violation counts with a Poisson distribution using the sample mean. Model the source metrics using the Normal distribution using the sample mean and variance.

605: If more than one training project is available, test the procedure or algorithm by training on all but one of the training projects and measuring the classification error on the remaining one.

As shown in FIG. 7 and also as discussed above, a method 700 of computing the index score for a project in accordance with the present invention comprises the following:

701: Compute the source code metric values and static analysis violation counts for all files in the project.

702: Submit each file individually to the Naive Bayesian model to compute a predicted probability that the file is fault-prone.

703: Convert the probability to an index score using the formula:

score=10·(1−prob(fault-prone))

704: Compute an index score for a directory of source files by taking the arithmetic mean (simple average) of the scores of all files in the directory and any subdirectories.

705: Compute an index score for the entire project by taking the arithmetic mean (simple average) of the scores of all files in the project.

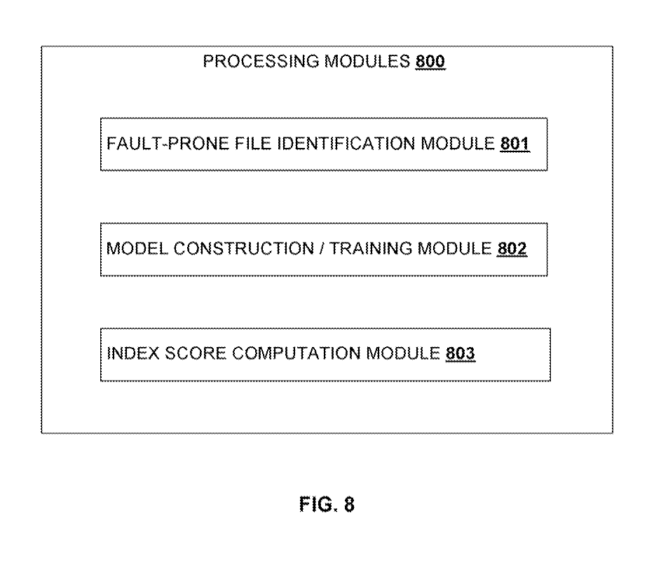

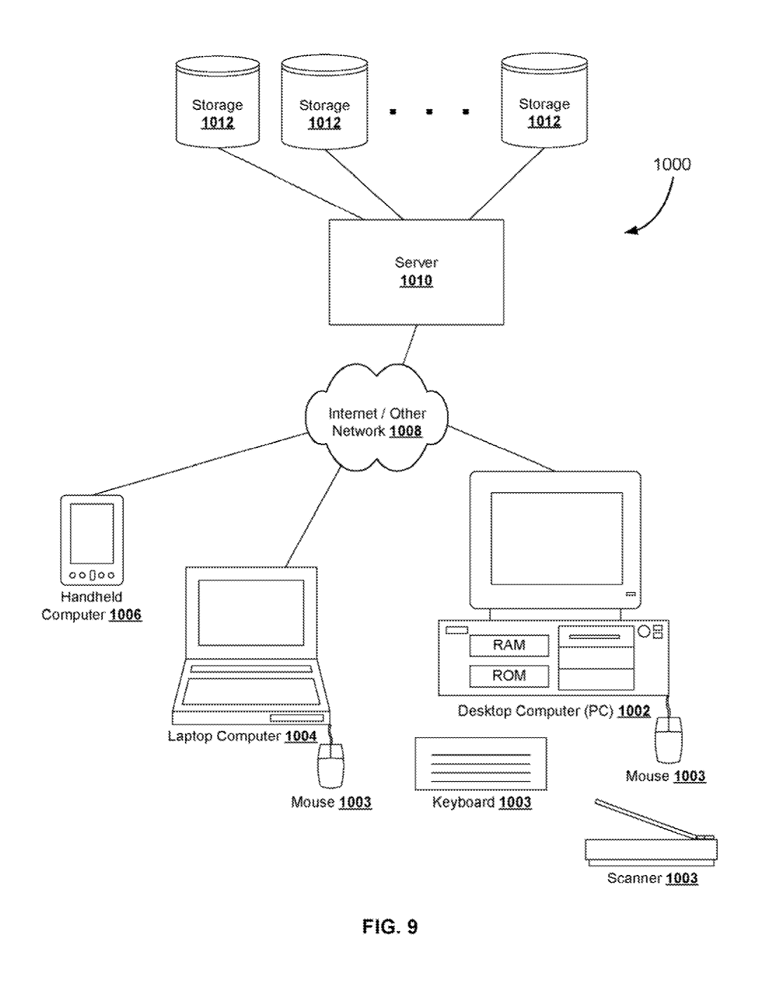

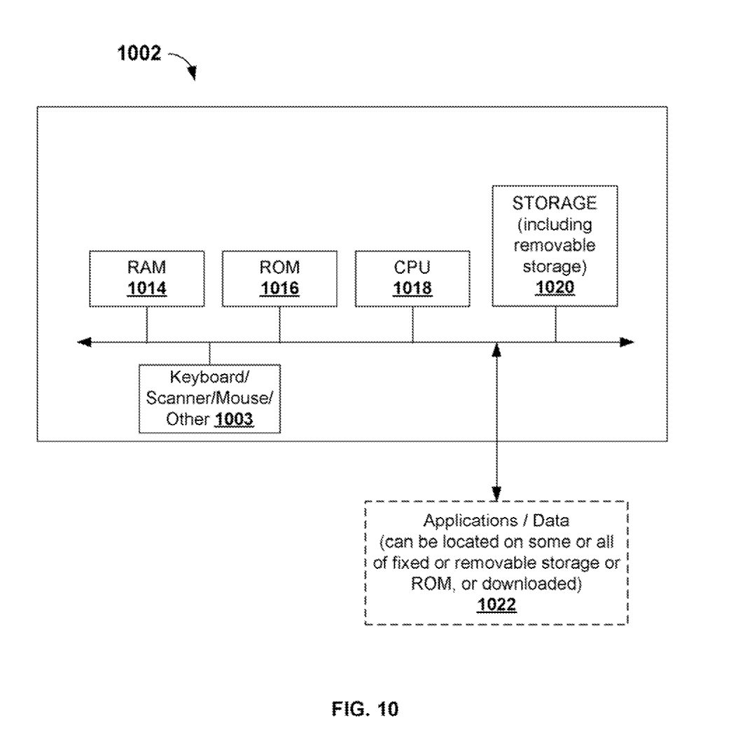

FIG. 8 is a schematic block diagram of processing modules 800 according to one embodiment of the present invention, implemented within an otherwise conventional digital processing apparatus 1002 like that shown in FIGS. 9 and 10, discussed below, wherein the respective modules (fault-prone file identification 801; model construction/training 802; and index score computation 800) carry out the operations discussed above in connection with the flowcharts of FIGS. 5, 6, and 7. Those skilled in the art will appreciate that the various processing modules can be provided by the elements of a conventional workstation, PC, or other computing platform suitably programmed and/or operated in accordance with the aspects of the invention discussed in this document. It will be understood that the organization, number, and description of modules in FIG. 8 is just one example of an embodiment of the invention, and the modules can be arranged differently or carry out different functions, whether singly or in combination, and still be within the spirit and scope of the present invention.

Additional information, discussion, examples, practices and implementations of the invention are discussed in the following Sections of this document, including Section 3 (description of a computer software code product in which the invention can be implemented); Section 4 (examples of static analysis violations in an online or other practice of the invention); and Section 5 (DEFS that may be utilized in an online or other practice of the invention). In referring to an online practice of the invention, one such practice or embodiment can be provided by an Internet-based, online website that provides functionality like that described above and elsewhere in this document, including the generating of software quality indexes, such as for open source software applications or other software applications

It is also noted that in Section 3, the software quality code index of the present invention, and related features, are variously referred to therein by terms including “Enerjy Index” and “Enerjy Index View”. The Enerjy Index and Enerjy Index View are presented as new features to be incorporated into a new upcoming version of Enerjy software.

It is further noted that Sections 4 and 5 set forth the content of HTML pages that can be utilized in connection with an online version of the present invention, such as on a website that provides for the generating of software quality indexes, such as for open source software applications or other software applications. The use of HTML is well known, and those skilled in the art will understand how such HTML content may be utilized in implementing the present invention as described herein.

Those skilled in the art will appreciate that the various examples, embodiments and practices of the invention set forth herein are provided by way of example, and not by way of limitation; and that numerous modifications, additions, subtractions and other practices of the invention are possible, and are within the spirit and scope of the present invention.

2. Typical Computing Environments in which the Invention May be Implemented

It will be understood by those skilled in the art that the described systems and methods can be implemented in software, hardware, or a combination of software and hardware, using conventional computer apparatus such as a personal computer (PC) or equivalent device operating in accordance with, or emulating, a conventional operating system such as Microsoft Windows, Linux, or Unix, using Java or other programming languages or packages, either in a standalone configuration or across a network. The various processing means and computational means described below and recited in the claims may therefore be implemented in the software and/or hardware elements of a properly configured digital processing device or network of devices. Processing may be performed sequentially or in parallel, and may be implemented using special purpose or reconfigurable hardware.

Methods, devices or software products in accordance with the invention can operate on any of a wide range of conventional computing devices and systems, such as those depicted by way of example in FIGS. 9 and 10 (e.g., network system 1000), whether standalone, networked, portable or fixed, including conventional PCs 1002, laptops 1004, handheld or mobile computers 1006, or across the Internet or other networks 1008, which may in turn include servers 1010 and storage 1012. As with many computing packages and applications in today's environment, the functions of the present invention discussed herein can be provided online via an Internet website; or in a stand-alone mode on a user's workstation or other computer, or by a combination of online and local software and hardware. (Sections 3, 4, and 5 below set forth additional information relating to software embodiments of the present invention, and Sections 4 and 5, particularly, relate to online software embodiments of the invention.)

For example, under conventional computer software and hardware practice, a software application in accordance with the invention can operate within, e.g., a PC 1002 like that shown in FIGS. 9 and 10, in which program instructions can be read from a CD-ROM 1016, magnetic disk or other storage 1020 and loaded into RAM 1014 for execution by CPU 1018. Data can be input into the system via any known device or means, including a conventional keyboard, scanner, mouse or other elements 1003.

The presently described systems and techniques have been developed for use in a Java programming environment. However, it will be appreciated that the systems and techniques may be modified for use in other environments.

Those skilled in the art will also understand that method aspects of the present invention can be carried out within commercially available digital processing systems, such as workstations and personal computers (PCs), operating under the collective command of the workstation or PC's operating system and a computer program product configured in accordance with the present invention. The term “computer program product” can encompass any set of computer-readable programs instructions encoded on a computer readable medium. A computer readable medium can encompass any form of computer readable element, including, but not limited to, a computer hard disk, computer floppy disk, computer-readable flash drive, computer-readable RAM or ROM element. or any other known means of encoding, storing or providing digital information, whether local to or remote from the workstation, PC or other digital processing device or system. Various forms of computer readable elements and media are well known in the computing arts, and their selection is left to the implementer.

Those skilled in the art will also understand that the method aspects of the invention described herein could also be executed in hardware elements, such as an Application-Specific Integrated Circuit (ASIC) constructed specifically to carry out the processes described herein, using ASIC construction techniques known to ASIC manufacturers. Various forms of ASICs are available from many manufacturers, although currently available ASICs do not provide the functions described in this patent application. Such manufacturers include Intel Corporation of Santa Clara, Calif. The actual semiconductor elements of such ASICs and equivalent integrated circuits are not part of the present invention, and will not be discussed in detail herein.

3. Description of an Exemplary Computer Software Code Product in which the Invention can be Implemented

This Section sets forth, in text and figures (typically screenshots generated by a computer system utilizing the described software product), a description of a computer software code product in which the invention can be implemented. In this Section, the software quality code index of the present invention, and related features, are variously referred to by terms including “Enerjy Index” and “Enerjy Index View”. The Enerjy Index and Enerjy Index View are presented as new features to be incorporated into a new, upcoming version of Enerjy software. This Section is divided into subsections, as follows:

3.1 Introduction to the Enerjy Software Eclipse Plug-in

3.2 Downloading and Installing Enerjy Software

3.3 Enerjy Configuration Wizard

3.4 Manual Configuration

3.5 Interpreting Results

3.6 Troubleshooting

3.1 Introduction to the Enerjy Software Eclipse Plug-in

As discussed above, Enerjy provides a new kind of software quality tool, i.e., one that uses a unique combination of metrics that have been proven to seek out the bug-prone areas of code so that a software developer or other user can allocate resources efficiently to clean up the pieces that need it the most. Based upon the analysis of millions of code quality metrics across tens of thousands of source code files, and the correlation of those metrics to real defects in the code, a unique statistical analysis allows Enerjy to predict the “bugginess” of any piece of Java source code to at least 80% accuracy. This technique is referred to herein as “Evidence-Based Software Quality Analysis.”

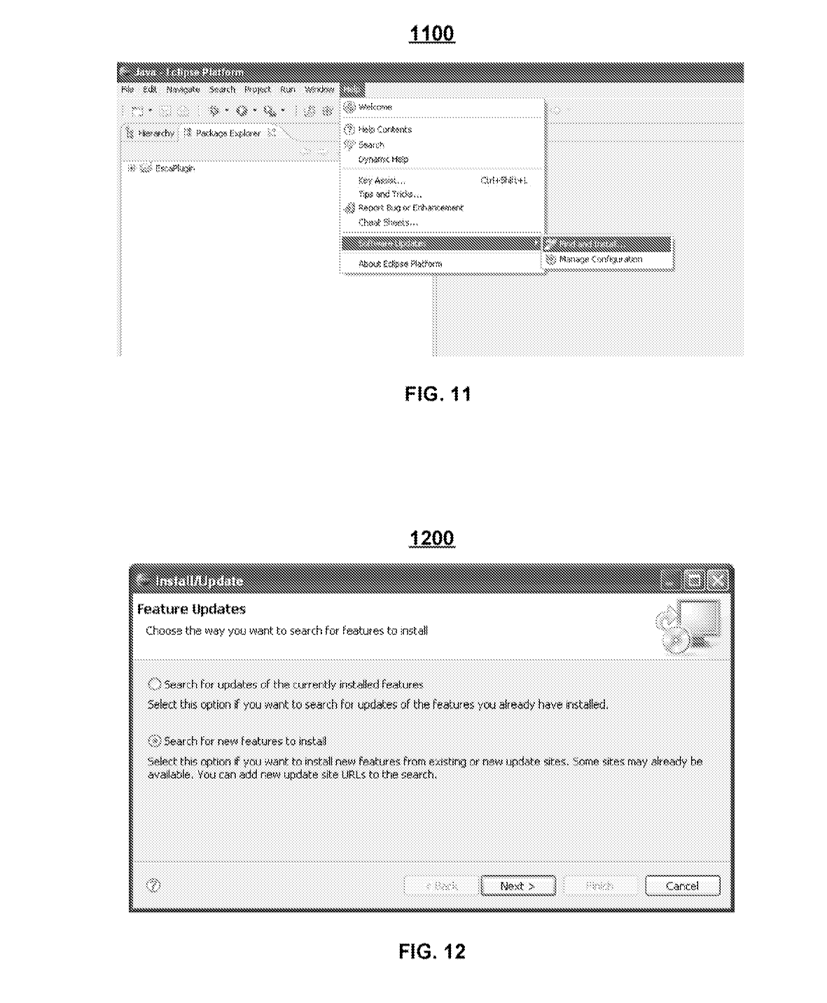

In an exemplary embodiment, illustrated in the screenshots set forth in FIGS. 11-27 and discussed below, Enerjy is configured as a plug-in for Eclipse that pinpoints problem areas in Java code by analyzing a range of metrics, and then allows a developer to zoom in on those areas that need attention the most. It includes a state-of-the-art static analyzer that analyzes code in the background, with no need for any change in the way work is conducted. It automatically analyzes any piece of code, any time that code changes.

3.2 Downloading and Installing Enerjy Software

In an exemplary embodiment, the Enerjy Eclipse plug-in solution can be downloaded and installed via the Automatic Software Update feature within the Eclipse IDE.

Within Eclipse, the user goes to Help, Software Updates and selects “Find and Install” on the dropdown menu, as shown in the screenshot 1100 set forth in FIG. 11.

The “Search for new features to install” radio button is selected, as shown in the screenshot 1200 set forth in FIG. 12.

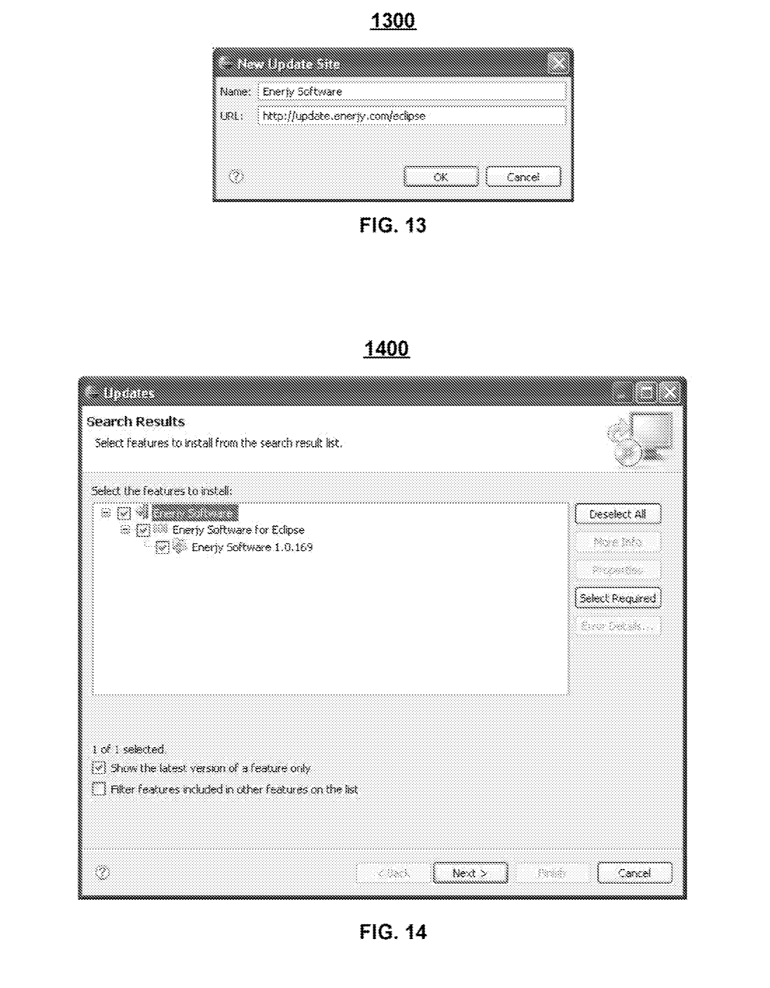

On the “New Update Site” subscreen 1300 shown in FIG. 13, “Enerjy Software” is added to the name field, and the URL “http://update.enerjy.com/eclipse” is added to the URL field. When the User and Password prompt appears a provided user name and password are added. In the present example, the provided user name is “privatebeta,” and the provided password is “enerjy.”

The “Finish” button is then clicked. Eclipse then searches for Enerjy Software and displays the screen 1400 shown in FIG. 14.

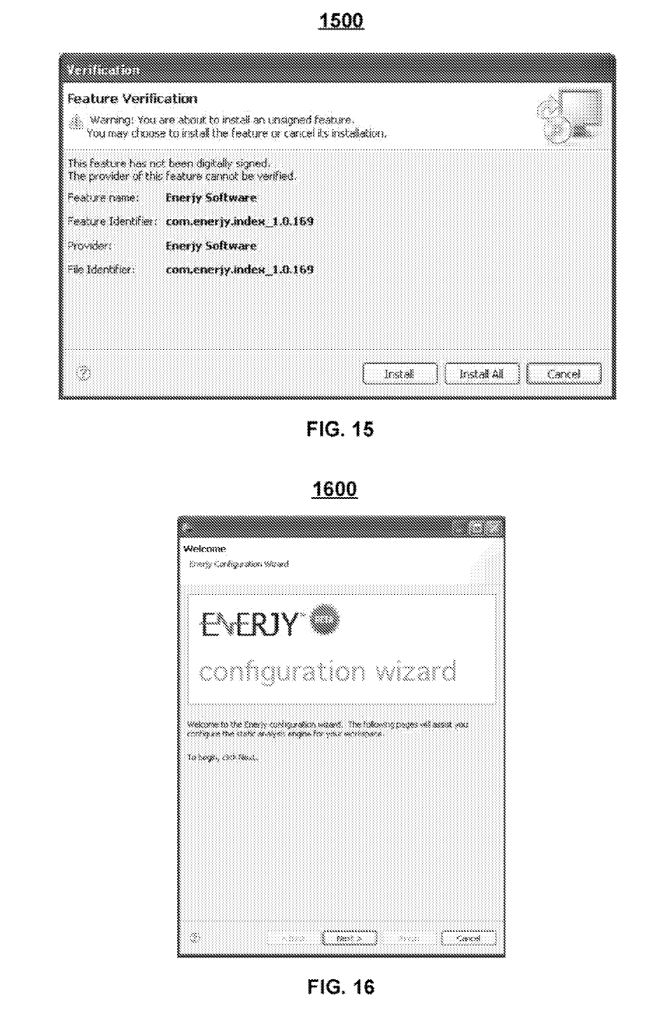

The “Enerjy Software” box is checked, and the “Next” button is clicked. The Feature Verification screen 1500 shown in FIG. 15 should appear. The “Install All” button is then clicked.

When installation is complete the user is prompted to restart Eclipse. After restarting, Eclipse will display the Enerjy Configuration Wizard, described in Section 3.3, immediately below.

3.3 Enerjy Configuration Wizard

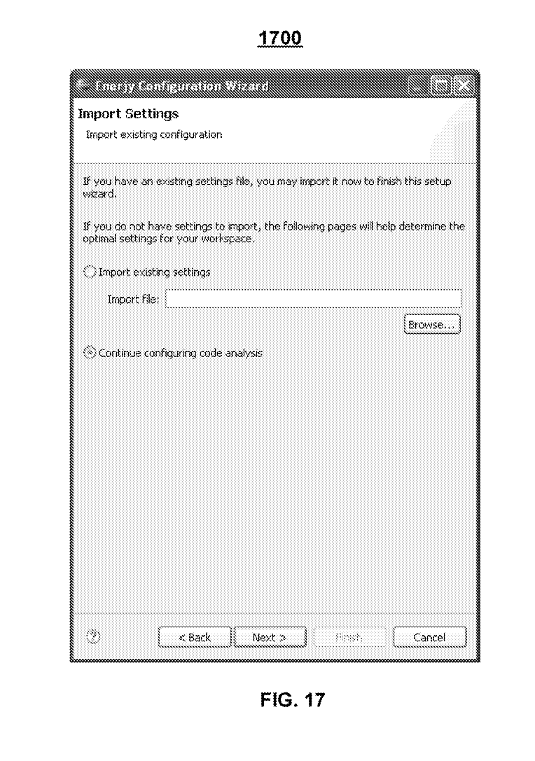

The Enerjy Configuration Wizard allows a developer or other user to fine-tune the settings, so that accurate metrics can be obtained from a given project or projects. FIG. 16 is a screenshot 1600 of the entry screen to the Wizard. The “Next” button is clicked to advance to the Import Settings screen 1700 shown in FIG. 17.

If an Enerjy configuration file has previously been exported, the exported file may be imported here. The “Next” button is then clicked to finish the wizard. Otherwise, the “Next” button is clicked to continue rule configuration.

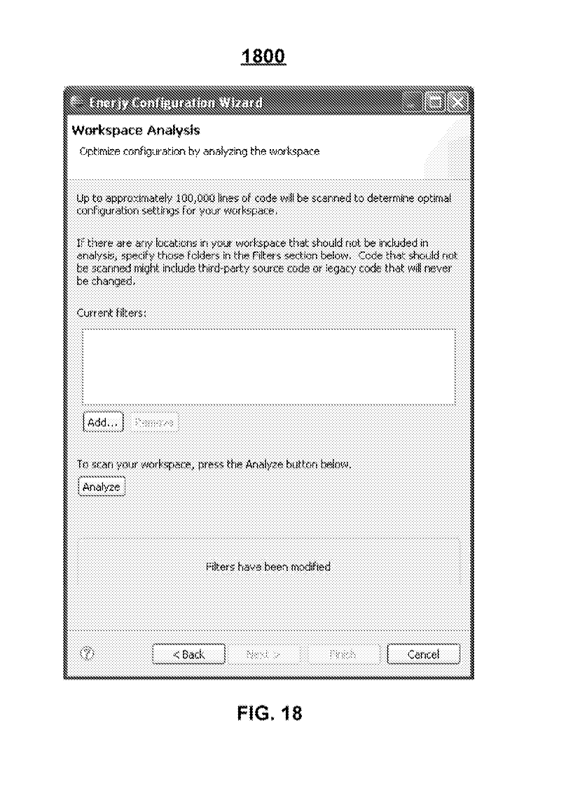

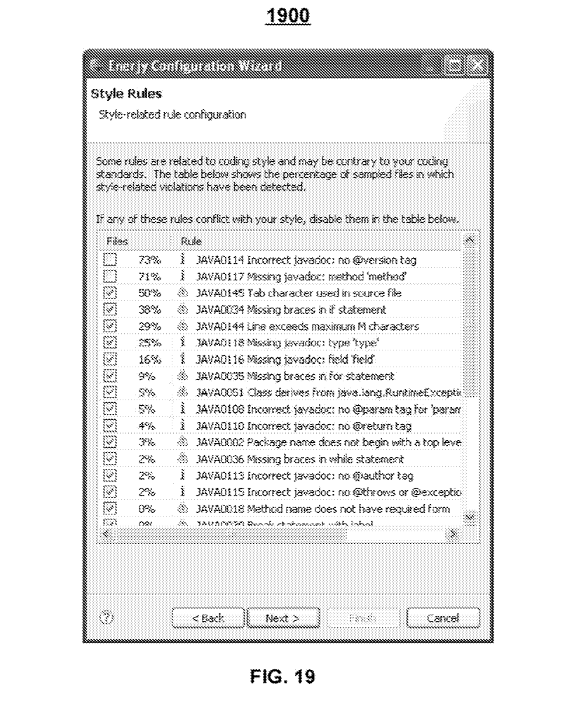

FIG. 18 is a screenshot 1800 of the Energy Configuration Wizard's Workspace Analysis screen. On this screen, a user can filter out any folders the user does not want Enerjy to examine, such as third-party or generated source code. Once the filters are configured, the “Analyze” button is clicked. The Wizard will then scan a sample of the user's workspace to try and determine the user's coding style. Once the analysis is complete, the “Next” button is clicked to continue to the Style Rules screen 1900 shown in FIG. 19.

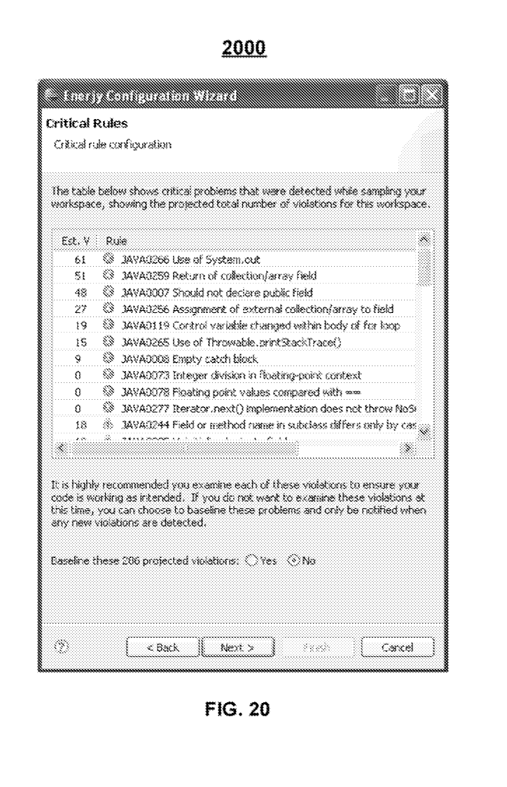

The Style Rules screen 1900 shows a list of style-related rules along with the percentage of the sampled files in which each was detected. Any rule that exists in a large percentage of the sample files is probably counter to the user's coding style and should be disabled by clearing the checkbox. There may be other rules in the list that do not occur often, such as JAVA0051 Class derives from java.lang.RuntimeException, but are still counter to the user's style and should be disabled. The “Next” button is clicked to continue to the “Critical Rules” screen 2000, shown in FIG. 20.

The “Critical Rules” screen 2000 shows a list of critical rules along with the projected total number of violations for this workspace. These are rules that indicate possible buggy, unfinished or bug-prone code. The wizard does not allow the user to disable these rules, and it is recommended that each violation be inspected to verify that the code is correct. However, if the user is in an environment where it is impractical to go back and review potentially large amounts of existing code then the wizard offers an option to base the violations. Baselining allows the user to ignore existing violations in the user's workspace without actually turning any rules off. This means that only violations of these rules in new or modified code will be displayed to the user.

The “Next” button is clicked to reach a similar window for Non-Critical Rules. These rules may still cause issues but are considered a lower priority than the critical errors already seen.

Running any Code Analysis tool over a large body of code can produce tens of thousands of warnings that overwhelm the user and demotivate anyone on the team to start correcting issues. For these non-bug-related violations it is recommended that existing problems be baselined in order to avoid becoming overwhelmed with a large number of non-critical violations and to allow the user to concentrate on the Critical violations.

It should be noted that the baseline is stored as a text file in each project (.escabaseline at the user's project root). Inside this file is a list of violations reported for each Java file that was baselined. It is recommended that this file be checked into the team's SCM, as this allows sharing of baselined violations and gets everyone on the same page. If the Enerjy Configuration Wizard is rerun, the .escabaseline files will be automatically checked out if the baseline is modified. The user will need to check the files back into the user's SCM when the wizard is complete.

It should be noted that the “import” feature of the wizard does not actually import baselines; the presence of the .escabaseline file implicitly “imports” the baseline data.

Once the changes are applied, the user can choose to automatically show the Enerjy Index view on completion of the Wizard.

To view the Enerjy Index within Eclipse manually, a user goes to Window—Show View—Other. “Enerjy Software” is expanded, and “Index” is selected.

3.4 Manual Configuration

Changing Rules: Individual rules can be reprioritized and turned on/off individually through the Enerjy Software—Code Analysis Rules preference page, as shown in the screenshot 2100 set forth in FIG. 21.

3.5 Interpreting Results

There are two primary ways to use the Enerjy Software plug-in for Eclipse to increase code quality: (1) the Enerjy Index View and (2) static code analysis. Each of these is described in turn.

3.5.1 The Enerjy Index View

The Enerjy Index View displays a measure of the quality of a user's projects based on the described evidence-based software quality analysis. The described analysis is based around identifying fault-prone files. These are the small number of files (typically around 10% of the total files in a project) that contain half of the bugs.

The index is a value between 0 and 10. For a file, the index reflects the probability that the file is fault-prone, with 0 representing a very high probability and 10 a very low probability. For a package, project or workspace, the index is the average of the index values for all contained files. File level is the most granular level the Index reports on.

Index values are displayed as four colored bars, showing the values for the currently selected file and its package and project as well as the overall index value for the workspace. If no file is selected, the view will show a gray bar for the file index and will show the selected package or project if any. The gray bar is also shown if a file is filtered or does not compile.

The color of each bar reflects its value:

| | |
|---|---|
| Red | 0-5 |
| Yellow | 5-8 |
| Green | 8-10 |

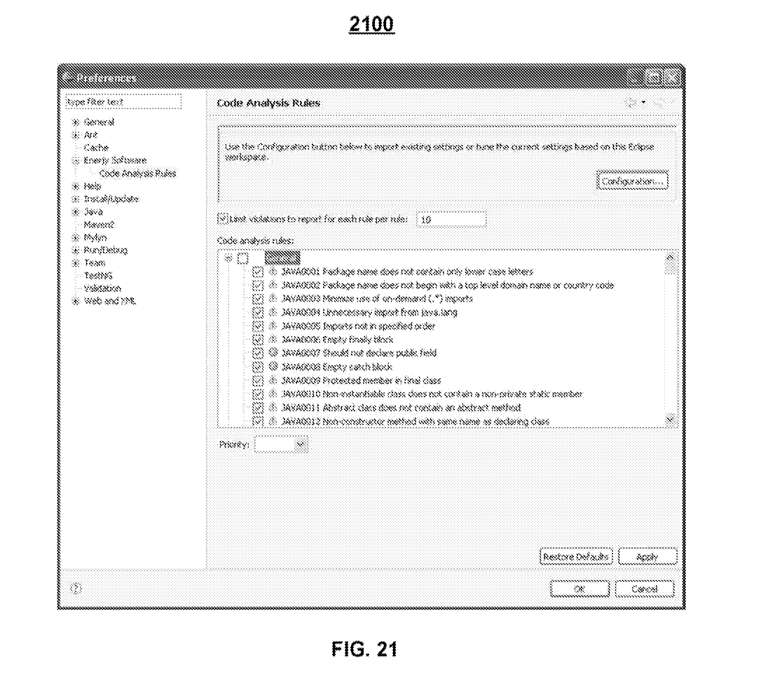

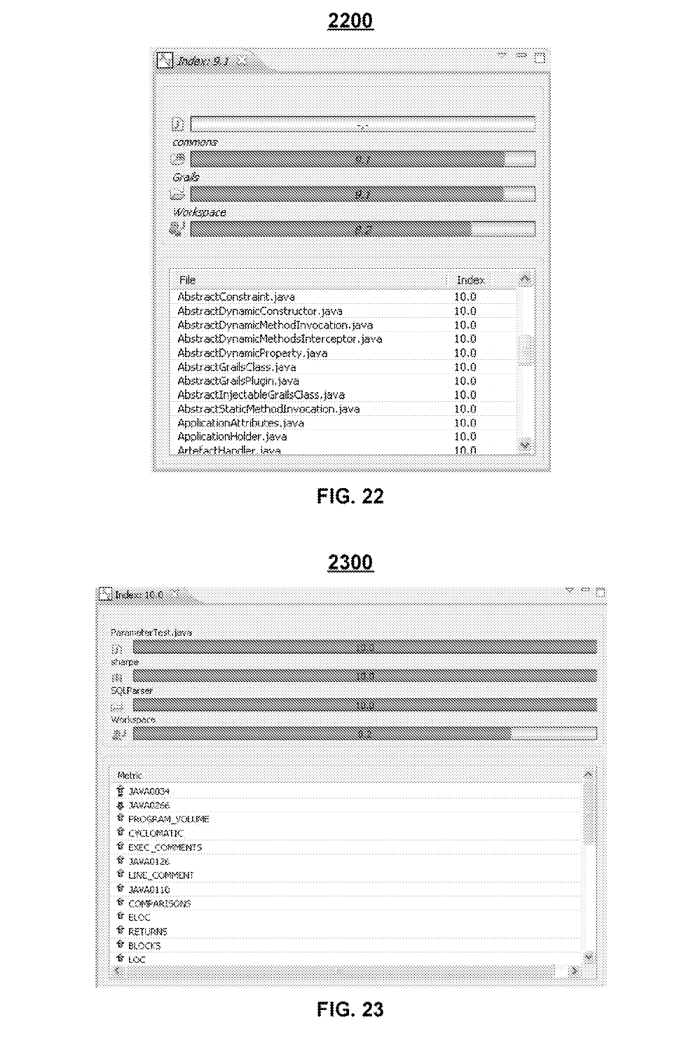

When there is no file selected, the table below the index bars shows a list of files in the current element along with their index value. They are sorted so that files with the lowest index score appear first. The user can double-click on a file in the table to open that file in an editor, as shown in the screenshot 2200 set forth in FIG. 22.

When a file is selected, the table below the index bars shows the metrics that had the greatest impact on the index value. They are sorted so that the metrics with the greatest impact appear first. Each metric has an arrow indicating whether it had a positive impact on the index (green up arrow) or a negative impact (red down arrow). To get more information on a particular metric, the F1 button is pressed, and the “Description” button is clicked. An exemplary resulting screen is set forth in the screenshot 2300 set forth in FIG. 23.

The user should use the index value as a means of identifying possible fault-prone code. However, it does not make sense to try to manage the index value directly by manipulating individual metrics. Instead code that has a low index value should be examined for static analysis violations and re-factored using traditional techniques. Also, some code is inherently fault-prone and it is impractical to aim for a perfect ten on every file. Based on a survey of open source software, it appears that any workspace or project with an index over 9 is very good.

3.5.2 The Static Code Analysis

The code analysis engine runs in the background so as users type code any infraction of the best practice rules (configured through the wizard) will be displayed immediately.

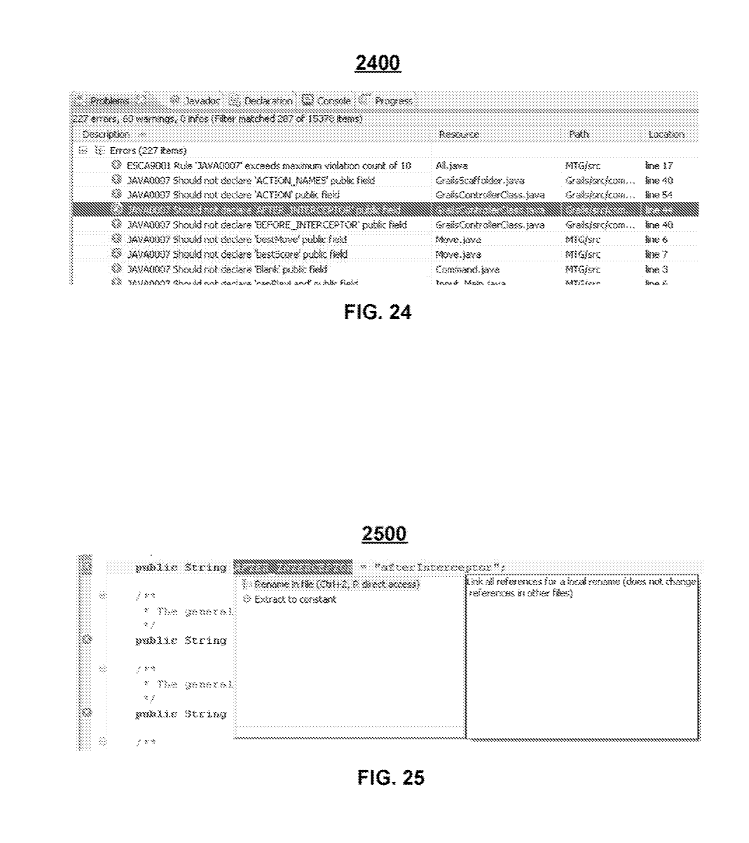

On installation of the plug-in the tool will perform an analysis of the code in the user's workspace with results in the Eclipse Problems pane, as set forth in screenshot 2400 set forth in FIG. 24. Icons appear to the left of each message and beside each questionable line or area of code in the Editing pane, indicating rule priority. Rule priority can help the user to identify which problems to solve first.

The user shouldn't be surprised by the number and variety of problems Enerjy CQ2 detects the first time it is run. It is thorough in its support of best-practices coding. Enerjy CQ2 messages can range from simple best-practices recommendations to hard errors. Enerjy CQ2 will help the user to debug the user's code, and help make the code as clean and efficient as possible.

To view additional information on a message, select the message in the Tasks window and press F1 to view Help.

Double-clicking any of the warnings will open the file and highlight the area of code affected. The user can then choose to correct or escape the violation.

There are three ways to deal with any violations:

(1) Manually edit the cede if necessary.

(2) Right click the error symbol in the editor pane and select Quick Fix to display a list of automated options to resolve the issue, as shown in the screenshot 2500 set forth in FIG. 25.

(3) If the warning has fired on code that the user wants to remain as is, the user adds an Escape Comment to the line above the code to filter it:
//ESCA-JAVAXXXX

If the user wishes the rule to be escaped throughout the entire file, add this escape comment to before the first instance of the warning:
//ESCA.*JAVAXXXX

3.6 Troubleshooting

3.6.1 “Out of Memory” Error when Performing the Initial Baseline or Resource Synchronization:
Although every effort has been made to minimize memory usage with Enerjy, it may be necessary to allocate additional memory to Eclipse to store code analysis violations and index values. Eclipse runs with a default of 256 MB of memory; see the Eclipse documentation at the following URL:
   http://help.eclipse.org/help32/topic/org.eclipse.platform.doc.user/tasks/running_eclipse.htm
for details on how to increase this limit.

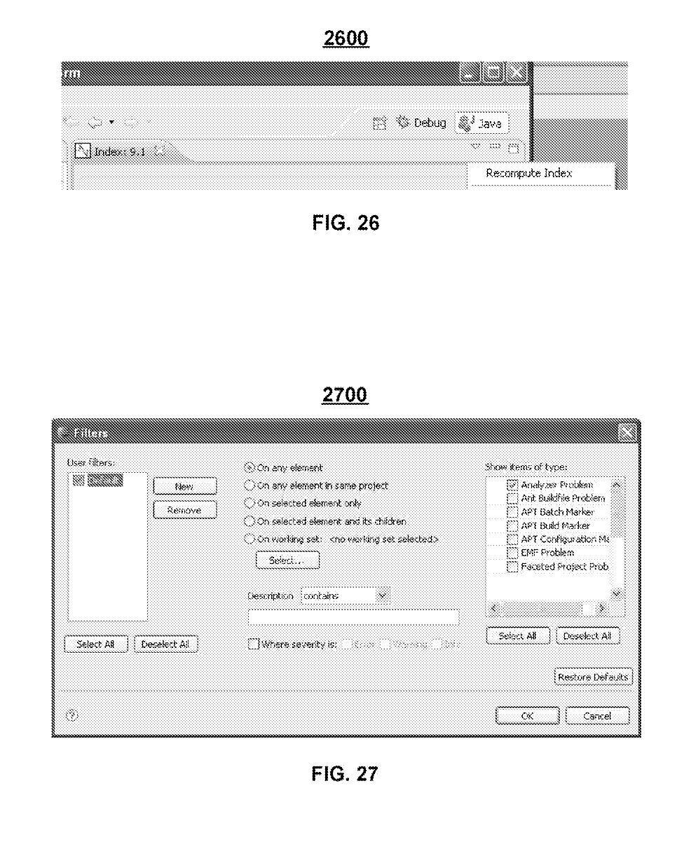

3.6.2 The Enerjy Index View Appears to be Out of Sync with the Source Code, or Displays Gray Bars for Source Files that have No Compilation Errors:
The index database may have become corrupted. To rebuild it, click the Context menu arrow in the Index view and select “Recompute Index,” as shown in the screenshot 2600 set forth in FIG. 26.

3.6.3 The Eclipse Problems Pane Shows No Errors or Warnings from the Code Analysis:
In the context menu for the Problems pane, ensure the filter for Analyzer problems is checked, as shown in the screenshot 2700 set forth in FIG. 27.

Having described the foregoing aspects, embodiments and practices of the invention, the following Sections 4 and 5 set forth examples of Static Analysis Violations in an online or other practice of the invention (Section 4); and examples of DEFS in an online or other practice of the invention (Section 5).

### 4. Examples of Static Analysis Violations in an Online or Other Practice of the Invention.

Section 4 sets forth Examples of Static Analysis Violations (JAVA0001-JAVA0288) in an online or other practice of the present invention. More particularly, this Section sets forth the content of HTML pages that can be utilized in connection with an online version of the present invention, such as on a website that provides for the generating of software quality indexes, such as for open source software applications or other software applications. As indicated in the following pages, such an online version can also employ the lava programming language. HTML and Java are well known, and those skilled in the art will understand how such HTML content and Java may be utilized in implementing the present invention as described herein.

### JAVA0001

### Package Name does not Contain Only Lower Case Letters

A package name should contain only lower case letters because package names are mirrored in the directory structure of the source code. Lowercase letters should be used for a consistent naming convention, and more important, so that one can move code between different operating systems without surprises.

Configuration: Enerjy Code Analyzer can be configured to allow numbers in package names.

### JAVA0002

### Package Name does not Begin with a Top Level Domain Name or Country Code

A package name should begin with a top level domain name or country code. To reduce the chance of name collision (choosing the same package name as someone else), prefix package names with the reversed form of a domain name own by the developer. For example, if the domain enerjy.com is owned, packages should all begin with com.enerjy. See the Java Language Specification, Sections 6.8.1 and 7.7.

### JAVA0003

### Minimize Use of on-Demand (.*) Imports

In general, it is easier to understand code if one imports types explicitly rather than using on-demand imports. Enerjy Code Analyzer will report this problem if code contains two or more on-demand imports and no single-type imports. Enerjy Code Analyzer will not report this problem if code contains a mix of on-demand and single-type imports on the grounds that one probably knows what one is doing when one mixes import types.

### Example

// Correct
import java.util.*;
// Correct
import java.awt.*;
import java.util.*;
import java.util.ListIterator;
// Incorrect
import java.awt.*;
import java.util.*;

### JAVA0004

### Unnecessary Import from Java.Lang

Java automatically imports the java.lang package, making it unnecessary and potentially confusing to explicitly include these imports in the developer's code.

Note: This rule applies to java.lang only and not subpackages. Types in java.lang reflect, for example, must be imported in the usual way.

### Example

// Correct
import java.lang.reflect.Method;
// Incorrect
import java.lang.Object;

### JAVA0005

### Imports not in Specified Order

Grouping and sorting imports improves readability and maintenance. This rule ensures each import statement is part of the appropriate group (has the same prefix as the previous) and is alphabetically sorted within that group.

Configuration: Enerjy Code Analyzer can be configured for the order in which groups should be organized. One prefix per line is specified; any imports that are not specified in the Configuration: list will be sorted after the last entry. The default is items under java followed by items under javax followed by all other items.

### Example

// Correct
import java.util.ArrayList;
import java.util.Iterator;
import java.util.Vector;
import javax.swing.JPanel;
import javax.swing.JTextField;
import com.abc.Utility;
// Incorrect
import com.abc.Utility; // group is out of order, should be after javax.*
import java.util.Iterator;
import java.util.Vector;
import java.util.ArrayList; // name is out of order,
// should be before java.util.Iterator
import javax.swing.JPanel;
import javax.swing.JTextField;

### JAVA0006

### Empty Finally Block

An empty finally block serves no purpose and should be removed. In addition to potentially slowing the code, it can confuse a maintenance programmer.

### JAVA0007

### Should not Declare Public Field

Public fields are discouraged because they break encapsulation by exposing the inner workings of a type to callers. Instead, use accessor (get/set) methods; because they serve the same purpose as a public field but let one modify the implementation as the program evolves. This rule does not apply to public final fields because exposing constants does not break encapsulation.

### JAVA0008

### Empty Catch Block

If an exception has been thrown then something has gone wrong. It is rarely correct to ignore this problem. One should do something, even if it is logging the exception somewhere to aid in future troubleshooting. Enerjy Code Analyzer will only report this problem if the catch block is totally empty. Even a comment is sufficient to suppress the rule. This comment should explain why no other code is required in the catch block.

### JAVA0009

### Protected Member in Final Class

A final class cannot be extended, making it unnecessary and potentially confusing to use the protected access modifier on a class member. Instead, use default, or package access.

### JAVA0010

### Non-Instantiable Class does not Contain a Non-Private Static Member

If a class contains only private constructors, it should contain at least one non-private static member. Otherwise, the class can only be used by other classes within the same compilation unit.

### Example

// Correct
class TheClass {
// Private constructor ensures the theClass objects
// are only created using the factory method
private TheClass( ) {
}
// Factory method
public static TheClass newInstance( ) {
return new TheClass( );
}
}
// Incorrect
class TheClass {
private int value;
private TheClass( ) {
value = 0;
}
// Can only be called from with this compilation unit
// since there's no way to create a TheClass object
// anywhere else
public getValue( ) {
return value;
}
}

### JAVA0011

### Abstract Class does not Contain an Abstract Method

A class should be declared abstract only if the intent is that subclasses can be created to complete the implementation. This means that at least one method in the class should be abstract. If the intent is to prevent instantiation of the class, one should declare a single private constructor. Marking the class abstract implies to anyone reading the code that it is intended to be the base of a class hierarchy.

### Example

// Correct way to prevent instantiation of a class
class Util {
private Util( ) {
}
public static method( ) {
}
}
// Incorrect way to prevent instantiation of a class
abstract class Util( ) {
public static method( ) {
}
}

### JAVA0012

### Non-Constructor Method with Same Name as Declaring Class

It is potentially confusing to have a method with the same name as the declaring class, because someone reading the code might mistakenly think it is a constructor.

### Example

// Correct
class TheClass {
// This is a constructor
TheClass( ) {
}
}
// Incorrect
class TheClass {
// This is not a constructor, but it looks like one
void TheClass( ) {
}
}

### JAVA0013

### Non-Blank Final Field is not Static

Non-blank final fields are usually constants. They should be declared static because there is no need to store a copy of the constant in every object.

### Example

// Correct
class TheClass {public static final int MAX_SIZE = 10;
}
// Incorrect
class TheClass {public final int MAX_SIZE = 10;
}

### JAVA0014

### Class with Only Static Members has Non-Private Constructor

There is no value in creating an instance of a type that contains only static members. To prevent such instantiation, ensure that type has a single, no-argument, private constructor and no other constructors.

### JAVA0015

### Package Class Contains Public Nested Type

Although this usage is legal, the visibility of the outer class limits the nested type's visibility to types within the same package. Check that the nested class really needs this level of visibility.

### JAVA0016

### Abstract Class Contains Non-Protected Constructor

Constructors in an abstract class can only be called from an instantiating subclass. Marking all constructors protected will help indicate this.

### JAVA0017

### Class Name does not have Required Form

Naming conventions can enhance the readability of code and form part of the documented coding standards in many organizations. This rule helps ensure that class names comply with one's standards.

Configuration: Enerjy Code Analyzer can be configured for allowable names. The default is for the name to begin with a letter followed by letters, digits or underscores.

### JAVA0018

### Method Name does not have Required Form

Naming conventions can enhance the readability of code and form part of the documented coding standards in many organizations. This rule helps ensure that class method names comply with one's standards.

Configuration: Enerjy Code Analyzer can be configured for allowable names. The default is for the name to begin with a letter followed by letters, digits or underscores.

### JAVA0019

### Interface Name does not have Required Form

Naming conventions can enhance the readability of code and form part of the documented coding standards in many organizations. This rule allows one to ensure that interface names comply with one's standards.

Configuration: Enerjy Code Analyzer can be configured for allowable names. The default is for the name to begin with a letter followed by letters, digits or underscores.

### JAVA0020

### Field Name does not have Required Form

Naming conventions can enhance the readability of code and form part of the documented coding standards in many organizations. This rule allows one to ensure that field names comply with one's standards. It is common to use a different naming convention for constant (for example, static final) fields, so they are excluded from this rule. See rule JAVA0022—Static final field name does not have required form.

Configuration: Enerjy Code Analyzer can be configured for allowable names. The default is for the name to begin with a letter followed by letters, digits or underscores.

### JAVA0021

### Interface Method Name does not have Required Form

Naming conventions can enhance the readability of code and form part of the documented coding standards in many organizations. This rule helps ensure that interface method names comply with one's standards.

Configuration: Enerjy Code Analyzer can be configured for allowable names. The default is for the name to begin with a letter followed by letters, digits or underscores.

### JAVA0022

### Static Final Field Name does not have Required Form

Naming conventions can enhance the readability of code and form part of the documented coding standards in many organizations. This rule helps ensure that static final field names comply with one's standards.

Configuration: Enerjy Code Analyzer can be configured for allowable names. The default is for the name to begin with a letter followed by letters, digits or underscores.

### JAVA0023

### Empty Finalize Method

Not only does an empty finalize method serve no purpose, it actually causes damage by suppressing finalization of any base classes. It is not necessary to provide a finalize method—but if one does it, one should always end with a call to super.finalize( ). See Java Language Specification 12.6.

### JAVA0024

### Empty Class

A class with no fields, methods or nested types serves no purpose. If the class is being used as a marker, (for example, to indicate that all subclasses have some property) it should be replaced with an equivalent interface.

### JAVA0025

### Method Override is Empty

It is unusual for a method override to be empty. Typically, the caller will be expecting the method to perform some task.

### JAVA0026

### Finalize Method with Parameters

The only way to declare a finalize method is public void finalize( ) [throws Throwable]. One can create other finalize methods that take parameters, but they will not be called automatically by the system, and may confuse anyone reading the code. One should reserve the name finalize for the real finalize method.

### JAVA0029

### Private Method not Used

A private method that is never used should be removed. It is potentially confusing for anyone reading the code.

### JAVA0030

### Private Field not Used

A private field that is never used should be removed. It is potentially confusing for anyone reading the code.

### JAVA0031

### Case Statement not Properly Closed

It is a common mistake in Java to accidentally allow one case in a switch statement to fall through to the next. This rule ensures that every case ends with one break, return, throw or continue. To allow fallthrough, one must specifically disable this rule for the case concerned. It is not necessary to apply this rule to the final case in a switch statement, though many developers like to in case additional cases are added to the statement at a later date.

Configuration: Enerjy Code Analyzer can be configured to determine whether this rule applies to the last case in a switch statement.

### Example

// Correct
switch (i) {
case 1:
System.out.println(“One”);
break;
case 2:
System.out.println(“Two”);
break;
}
// Incorrect
switch (i) {
case 1:
System.out.println(“One”);
// Forgot a break here - will print “One” and “Two”
// when i is 1
case 2:
System.out.println(“Two”);
break;
}

### JAVA0032

### Switch Statement Missing Default

It is good practice to include a default case in every switch statement, even if it contains only a comment or, better, an assertion. This shows that one has considered the case where none of the earlier conditions hold.

### Example

// Correct
switch (i) {
case 1:
...
case 2:
...
default:
// can never happen
assert false;
}
// Incorrect
switch (i) {
case 1:
...
case 2:
...
}

### JAVA0033

### Default

### Not Last Case in Switch Statement

It is conventional for the default case to be the last case in a switch statement. Putting it anywhere else can be confusing for someone reading the code.

### Example

// Correct
switch (i) {
case 1:
...
case 2:
...
default:
...
}
// Incorrect
switch (i) {
case 1:
...
default:
...
case 2:
...
}

### JAVA0034

### Missing Braces in if Statement

If the then or else clause in an if expression consists of a single statement, Java does not require one to enclose the statement in braces. However, this is a dangerous practice. If the clause needs to be expanded to multiple statements, it is easy for a maintenance programmer to forget to introduce the braces, which will create a bug.

### Example

For example, although risky, the following is correct:

if (condition)

doSomething( );

However, the following code does not do what the programmer intended:

if (condition)

doSomething( );

doSomethingElse( );

Because it is equivalent to the following:

if (condition) {
doSomething( );
}
doSomethingElse( );

A maintenance programmer would not have been able to make this mistake if the original code had been written as follows:

if (condition) {
doSomething( );
}

The only time this rule doesn't apply is when the else clause is itself another if statement, as follows:

if (condition1) {
doSomething( );
}
else if (condition2) {
doSomethingElse( );
}

### JAVA0035

### Missing Braces in for Statement

If the body of a for loop consists of a single statement, Java does not require one to enclose the statement in braces. However, this is a dangerous practice. If the clause needs to be expanded to multiple statements, it is easy for a maintenance programmer to forget to introduce the braces, which will create a bug.

### Example

For example, although risky, the following code is correct:

for (int i=0; i<3; ++i)

doSomething( );

However, the following code does not do what the programmer intended:

for (int i=0; i<3; ++i)

doSomething( );

doSomethingElse( );

Because it is equivalent to:

for (int i = 0 ; i < 3 ; ++i) {
doSomething( );
}
doSomethingElse( );

A maintenance programmer would not have been able to make this mistake if the original code had been written as follows:

for (int i = 0 ; i < 3 ; ++i) {
doSomething( );
}

This rule also detects for loops with an accidentally empty body. For example, the following code is legal:

for (int i=0; i<3; ++i);

doSomething( );

But it is equivalent to:

for (int i=0; i<3; ++i) { }

doSomething( );

This is probably not what the developer intended.

### JAVA0036

### Missing Braces in while Statement

If the body of a while loop consists of a single statement, Java does not require one to enclose the statement in braces. However, this is a dangerous practice. If the clause needs to be expanded to multiple statements, it is easy for a maintenance programmer to forget to introduce the braces, which will create a bug.

### Example

For example, although risky, the following code is correct:

while (condition)

doSomething( );

However this code does not do what the programmer intended:

while (condition)

doSomething( );

doSomethingElse( );

Because it is equivalent to:

while (condition) {
doSomething( );
}
doSomethingElse( );

A maintenance programmer would not have been able to make this mistake if the original code had been written as follows:

while (condition) {
doSomething( );
}

This rule also detects while loops with an accidentally empty body. For example, the code is legal:

while (condition);

doSomething( );

But it is equivalent to the following:

while (condition) { }

doSomething( );

This is probably not what the developer intended.

### JAVA0038

### Non-Case Label in Switch Statement

A non-case label in a switch statement is probably the result of a missing or mistyped case label.

### Example

// Correct
switch (i) {
case ONE:
...
case TWO:
...
}
// Incorrect
switch (i) {
caseONE: // Forgot the space between ‘case’ and the
// value ‘ONE’
...
TWO: // Forgot the keyword ‘case’
}

### JAVA0039

### Break Statement with Label

Labeled break statements are GOTOs by another name. Like GOTO, they occasionally lead to clearer code, but usually add no value and should be removed.

### JAVA0040

### Switch Statement Contains N Cases

### Maximum: M

A switch statement containing too many cases can be difficult to understand. This rule considers consecutive case labels as a single case, as consecutive labels are typically used to implement common functionality over a range of values.

Configuration: One can configure the maximum allowed cases per switch statement.

### JAVA0041

### Nested Synchronized Block

Nesting synchronized blocks can lead to deadlock unless both blocks are synchronized on the same object.

### Example

Consider the following example:

Thread A
synchronized(a) {
synchronized(b) {
...
}
}
Thread B
synchronized (b) {
synchronized (a) {
...
}
}

Thread A may acquire the lock on a and then yield to thread B, which acquires the lock on b. Neither thread is then able to continue.

Even if one ensures that one always acquire locks in the same order, one can still have problems because wait only unlocks the monitor for the object on which it is called. In the next example, if Thread A runs first, the call to b.wait( ) will release the lock on b but not the lock on a. Thread B is then unable to run to unlock thread A and the application is deadlocked.

Thread A
synchronized (a) {
synchronized (b) {
b.wait( );
}
}
Thread B
synchronized (a) {
synchronized (b) {
b.notify All( );
}
}

### JAVA0042

### Empty Synchronized Statement

An empty synchronized block serves no purpose and can hurt performance.

### JAVA0043

### Inner Class does not Use Outer Class

A nested class that does not use any instance variables or methods from any of its outer classes can be declared static. This reduces the dependency between the two classes, which enhances readability and maintenance.

### Example

// Correct
class Log {
static class Position {
private int line;
private int column;
Position(int line, int column) {
this.line = line;
this.column = column;
}
}
}
// Incorrect
class Log {
// Position never uses the enclosing Log instance,
// so it should be static
class Position {
private int line;
private int column;
Position(int line, int column) {
this.line = line;
this.column = column;
}
}
}

### JAVA0044

### Serializable Class with No Instance Variables

If a class has no instance variables, it is not necessary to declare it serializable, even if one intends subclasses derived from it to be serializable. It is sufficient to provide a no-argument constructor.

### JAVA0045

### Serializable Class with Only Transient Fields

A class with only transient fields has no state and therefore should not be declared serializable. If one wants to allow subclasses to be serializable, then it is sufficient to provide a no-argument constructor. This rule does not apply if a class provides custom implementations of writeObject or readObject.

### JAVA0046

### Name of Class not Derived from Exception Ends with ‘Exception’

Only classes that extend java.lang.Exception should have a name ending with ‘Exception’. This makes it clear to anyone reading the code whether the class is an exception type or not.

### JAVA0047

### Serializable Class Derives from Invalid Base Class

A serializable class can only be deserialized if its superclass is also serializable or if its superclass has an accessible, no-argument constructor. If neither of these conditions hold, a NotSerializableException is thrown when one tries to deserialize an object of the given type.

### Example

// Correct
class Base implements Serializable
{
...
}
// Derived can be deserialized because Base is
// serializable
class Derived implements Serializable
{
...
}
// Correct
class Base
{
public Base( ) {
}
...
}
// Derived can be deserialized because Base has a
// no-argument constructor
class Derived implements Serializable
{
...
}
// Incorrect
class Base
{
public Base(int i) {
}
...
}
// Derived cannot be deserialized because Base does not
// have a no-argument constructor and is not
// serializable
class Derived implements Serializable
{
...
}

### JAVA0048

### Name of Class Derived from Exception does not End with ‘Exception’

It is conventional for a class that extends java.lang.Exception to have a name that ends with Exception. This makes the intended use of the class clear to anyone reading the code. Examples include NullPointerException and IllegalArgumentException.

### JAVA0049

### Nested Block at Depth N

### Maximum: M

Deeply nested blocks of code reduce readability and maintainability.

Configuration: Enerjy Code Analyzer can be configured for the allowable depth. The default is 5.

### JAVA0050

### Class Derives from Java.Lang.Error

Exceptions derived from java.lang.Error are reserved for situations from which an ordinary program is not expected to recover; for example, a catastrophic failure inside the JVM. User exception types should derive from java.lang.Exception. See Java Language Specification 11.5.

### JAVA0051

### Class Derives from Java.Lang.RuntimeException

Exceptions derived from java.lang.RuntimeException are unchecked exceptions that are reserved for common failures within the java language, such as NullPointerException. User exception types should derive from java.lang.Exception. See Java Language Specification 11.5.

### JAVA0052

### Class Derives from Java.Lang.Throwable

Throwable is the most generic exception type. User exception types should derive from java.lang.Exception, not java.lang.Throwable. See Java Language Specification 11.5.

### JAVA0053

### Unused Label

A label that is never used should be removed. It is potentially confusing, for anyone reading the code.

### JAVA0054

### Inheritance Depth N Exceeds Maximum M

A complex inheritance hierarchy is difficult to understand. This rule only counts the inheritance depth within one's source code—it does not include layers of inheritance inside code libraries that one is using.

Configuration: Enerjy Code Analyzer can be configured for the allowable inheritance depth. The default is 3.

### JAVA0055

### Class should be Interface

A class that contains only abstract methods and static final fields is probably better as an interface. Though Java only allows a class to have a single superclass, a class can implement many interfaces. Making this class an interface will provide greater flexibility.

### JAVA0056

### Unnecessary Abstract Modifier for Interface or Annotation

The abstract modifier on an interface declaration is implicit and should not be specified in new programs. See Java Language Specification 9.1.1.1.

### Example

// Correct
interface IComparable {
...
}
// Incorrect
abstract interface IComparable {
...
}

### JAVA0057

### Unnecessary Default Constructor

Java automatically provides a default public constructor if a class does not explicitly declare any constructors. If one's class does not require initialization, there is no need to provide a constructor.

### Example

// Correct
class TheClass {
// Methods and fields - no explicit constructors
...
}
OK
class TheClass {
// Initialization required, so provide a constructor
public TheClass(int i) {
...
}
...
}
// Incorrect
class TheClass {
// This constructor serves no purpose and can be
// removed
public TheClass( ) {
}
...
}

### JAVA0058

### Constructor Calls Super( )

There is no need for a constructor to explicitly invoke its superclass' default constructor. The compiler automatically supplies this call. One should only explicitly call super( ) when one must pass parameters to a superclass' constructor.

### Example

// Correct
class Base {
Base( ) {
...
}
}
class Derived {
Derived( ) {
// Code with no call to super( )
}
}
// Correct
class Base {
Base(int i) {
...
}
}
class Derived {
Derived(int i) {
// Call to super( ) ok because we need to pass i
super(i);
}
}
// Incorrect
class Base {
Base( ) {
...
}
}
class Derived {
Derived( ) {
// Call to super( ) not required
super( );
...
}
}

### JAVA0059

### Method Override Only Calls Super( )

A method override that only calls its super method is unnecessary and confusing. The method can be safely removed.

### JAVA0061

### Inaccessible Member in Anonymous Class

There is no value in defining any new package, protected or public level members in an anonymous class because they cannot be accessed. Any new fields or methods added to an anonymous class should be declared private.

### Example

// Correct
...
node.accept (new ASTVisitor( ) {
private int count;
...
}
);
...
// Incorrect
...
node.accept (new ASTVisitor( ) {
public int count;
...
}
);
...

### JAVA0062

### Public Class Missing Public Member or Protected Constructor

A public class should have at least one public member or at least one protected constructor to be useful when instantiated or extended. Consider restricting such classes to package scope.

### JAVA0063

### Identifier Name should not Contain ‘$’

Although it is legal to use $ in a Java identifier it is strongly discouraged. $ is used internally by Java, particularly when building the names of nested classes. If one uses this character, one may encounter unexpected name conflicts.

### Example

// Correct
class TheClass {
}
// Incorrect
class The$Class {
}

### JAVA0061

### N Variations of Identifier Name

### Maximum: M

Java is case sensitive and can easily distinguish between fields called var, VAR, Var, and vaR, for example. But using multiple identifiers that differ only in case is confusing to most people. By default, this rule detects any type, field, method or variable name declared in this file that has at least one case-sensitive variant.

Configuration: Enerjy Code Analyzer can be configured for the number of allowed variants. The default is to not allow any variations.

### Example

// Correct
class TheClass {
private int count;
int getCount( ) {
return count;
}
}
// Incorrect
class TheClass {
// Identifier ‘count’ used twice - once with c,
// once with C
private int count;
int Count( ) {
return count;
}
}

### JAVA0065

### Unnecessary Final Modifier for Method in Final Class

Every method in a final class is implicitly final. There is no need to explicitly mark each individual method as final.

### Example

// Correct
final class TheClass {
void doSomething( ) {
}
}
// Incorrect
final class TheClass {
// Unnecessary final modifier on method
final void doSomething( ) {
}
}

### JAVA0066

### Unnecessary Modifier for Interface Nested Type

A nested type in an interface is implicitly public and static. There is no need to explicitly provide these modifiers.

### Example

// Correct
interface IAnalyzable {
class Data {
...
}
}
// Incorrect
interface IAnalyzable {
public static class Data {
...
}
}

### JAVA0067

### Array Descriptor on Identifier Name

Variable declarations are easier to read if array descriptors ([ ]) are applied to the variable type rather than the variable name. If the descriptors have been placed with the name to allow for multiple declarations on a single line, the declarations should be rewritten, one per line.

### Example

// Correct
...
int[ ] counts;
...
// Incorrect
...
int counts[ ];
...
// Incorrect;
...
int count, counts[ ];
...
// Correct;
...
int count;
int[ ] counts;
...

### JAVA0068

### Modifiers not Declared in Recommended Order

One should always declare type, field and method modifiers in the same order. This provides consistency and ensures that key information about the declaration, particularly the level of access, is readily visible. The recommended orders are:

Type: public protected private abstract static final strictfp

Field: public protected private static final transient volatile

Method: public protected private abstract static final synchronized native strictfp

### JAVA0071

### String Compared with ==

In Java the == operator applied to objects returns true only when comparing an object to itself. Comparing two different objects, even if they have the same value, always returns false. Use equals( ), not == to compare the value of two strings.

### Example

// Correct
if (strName.equals(“Object”) {
...
}
// Incorrect
// This will always be false
if (strName == “Object”) {
...
}

### JAVA0073

### Integer Division in Floating-Point Context

Dividing two integers will result in an integer value. In a floating-point context such as assignment or as a parameter to a method, which may result in unexpected behavior. Consider casting the operands to float or double.

### Example

// Correct
float f = 2f/3f;
float f = (float)2 / 3
// Incorrect
float f = 2 / 3;
float f = (float)(2 / 3);

### JAVA0074

### Use of Object.Notify( )

The use of Object.notify( ) can produce a unexpected behavior if multiple threads are waiting for different conditions on the same object. Use Object.notifyAll( ) to awaken all waiting threads, so they each can check their condition.

### Example

// Incorrect
// Thread A
synchronized(obj) {
while (!bOneCondition) {
try { obj.wait( );
}
catch (InterruptedException e) { }
}
}
// Thread B
synchronized(obj) {
while (!bAnotherCondition) {
try { obj.wait( ); } catch (InterruptedException e) { }
}
}
// Thread C
synchronized(obj) {
// Wrong - if Thread B is awakened by notify( ), it
// will immediately begin waiting again;
// Thread A will never he awakened
bOneCondition = true;
obj.notify( );
}
// Correct
// Threads A and B as above
// Thread C
synchronized(obj) {
// Correct - both Thread A and Thread B will be
// awakened; Thread A will stop waiting; Thread B
// will start waiting again since its condition
// has not yet been satisfied
bOneCondition = true;
obj.notifyAll( );
}

### JAVA0075

### Method Parameter Hides Field

Naming a method parameter the same as a visible field can cause confusion. For example, one may introduce a bug if one forgets to use “this.” to refer to the field. The only exception is with constructor and setter methods, where it is conventional to use the name of the private field being set as the name of the parameter.

### Example

// Correct
...
private int value;
void setValue(int value) {
this.value = value;
}
...
// Incorrect
private int value;
void doSomething(int value) {
// Oops, wanted to print the instance variable value,
// not the parameter
System.out.println(“this.value == “ + value);
}

### JAVA0076

### Use of Magic Number

Code is generally easier to read and maintain if magic numbers (hard coded numeric literals) are replaced with descriptively named static final fields. However, because small integers are common, this rule does not apply to −5 thru 5.

### Example

// Correct
private static final int BORDER_WIDTH = 7;
...
void addBorder( ) {
width += BORDER_WIDTE;
}
// Incorrect
...
void addBorder( ) {
width += 7;
}

### JAVA0077

### Private Field not Used in Declaring Class

A private field that is not used in its declaring class may actually belong in the inner or outer class in which it is used. If that is not possible, add accessor methods to clarify that the field is being maintained only to provide state for another class.

### Example

// Correct
class TheClass {
private HashMap map;
int getMap( ) {
if (null == map) {
map = new HashMap( );
}
return map;
}
class Inner {
void addToMap(Object key, Object val) {
getMap( ).put(key, val);
}
}
}
// Incorrect
class TheClass {
private HashMap map;
class Inner {
boolean addToMap(Object key, Object val) {
if (null == map) {
map = new HashMap( );
}
map.put(key, val);
}
}
}

### JAVA0078

### Floating Point Values Compared with ==

In general, computers cannot store or perform floating-point computations with floating point numbers with complete accuracy due to internal rounding errors. For example, if a and b are arbitrary floating-point numbers, it is usually the case that a/b*b !=a. This means that is risky to attempt to compare floating point values for exact equality. It is a better practice to ensure that numbers are sufficiently close.

### Example

// Correct
private static final double EPSILON = 0.00001;
private boolean areDoublesEqual(double a, double b) {
return Math.abs(a - b) < EPSILON;
}
public boolean compareDoubles(doubles a, doubles b) {
return areDoublesEqual(a, b);
}
// Incorrect
public boolean compareDoubles(double a, double b) {
return a == b;
}

### JAVA0079

### Use of Instance to Reference Static Member

Static fields and methods are an attribute of the class, not an instance of the class. To improve clarity, refer to them using the class name instead of the instance variable name.

### Example

// Correct
class TheClass {
static final int SIZE = 15;
...
}
class Test {
void printSize( ) {
System.out.println(TheClass.SIZE);
}
}
// Incorrect
class TheClass {
static final int SIZE = 15;
...
}
class Test {
void printSize( ) {
TheClass obj = new TheClass( );
System.out.println(obj.SIZE);
}
}

### JAVA0080

### Import Declaration not Used

Unused import declarations are redundant code, which may potentially confuse a maintenance programmer.

### JAVA0081

### Boolean Literal in Comparison

Avoid explicit comparisons with Boolean literals. It is better to use well-chosen variable and method names.

### Example

// Correct
...
if (isMoreToDo( )) {
doMore( );
}
// Incorrect
...
if (isMoreToDo( ) == true) {
doMore( );
}

### JAVA0082

### Unnecessary Widening Cast

There is no need to provide an explicit cast to a superclass or superinterface of the static type of an object.

### Example

```
      // Correct
      ...
      Object o = new HashMap( );
      ...
      // Incorrect
      ...
      // Cast unnecessary - the compiler knows that every
      // HashMap is an Object
      Object o = (Object)new HashMap( );
...
```

### JAVA0083

### Unnecessary Instanceof Test

An instanceof test against a superclass or superinterface of the static type of an object is unnecessary and should be removed.

### Example

```
      // Incorrect
      HashMap map;
      // Test unnecessary - HashMap implements Map so it is
      // always true
      if (map instanceof Map) {
      ...
}
```

### JAVA0084

### Should Use Compound Assignment Operator

Compound assignments are easier to read than the equivalent long form. They are also potentially more efficient because the affected variable location must only be computed once.

### Example

// Correct
a += 1;
// Incorrect
a = a + 1;

### JAVA0085

### Use of Sun.* Class

The sun.* classes are not part of the official Java API and thus may vary between platforms and JDK releases. For portability, use an equivalent class from the Java API wherever possible.

### JAVA0087

### Use of Thread.Sleep( )

Thread.sleep( ) efficiently suspends execution of the current thread, but does not release monitors. This may prevent other threads from being able to run. It is better to use wait( )/notify All( ).

### JAVA0089

### Use of Restricted Package

Some coding standards discourage the use of types from specific packages. This rule identifies the use of any type contained in a configured list of restricted packages.

Configuration: Enerjy Code Analyzer can be configured for a list of restricted packages by specifying one package per line. To prevent the use of types from a package and all of its subpackages, append “.*” to the package name. Otherwise, types in subpackages of the specified package will not be identified by this rule. For example, if one specifies java.util and java.awt.* when configuring Enerjy Code Analyzer, this rule will identify java.util.ArrayList, but not java.util.arrays.ArrayList. However, all types in java.awt and its subpackages will be identified.

### JAVA0092

### Use of Restricted Type

Some coding standards discourage the use of specific types. This rule will identify the use of any configured restricted types.

Configuration: Enerjy Code Analyzer can be configured for a list of restricted types by specifying one fully qualified type per line.

### JAVA0093

### Redundant Assignment

Assigning a variable to itself serves no purpose. This usually signifies an error where a qualifier has been omitted from one side of the assignment. A particularly common case is in constructors and setter methods, where it is conventional to use the same name for the method parameter and the private field being assigned.

### Example

// Correct
class TheClass {
private int value;
TheClass(int value) {
this.value = value;
}
}
// Incorrect
class TheClass {
private int value;
TheClass(int value) {
// Forgot ‘this.’ on the first value - redundant
// assignment and this.value remains uninitialized
value = value;
}
}

### JAVA0094

### Field Hides a Superclass Field

It is potentially confusing to create a field in a class that has the same name as a visible field in a superclass.

### JAVA0095

### Uninitialized Private Field

In Java it is easy to forget that private fields are references to objects that must be created before they are used. This rule detects private fields that are read but are never assigned to within a class.

### Example

// Correct
class TheClass {
private HashMap map = new HashMap( );
void addEntry(Object key, Object value) {
map.put(key, value);
}
}
// Incorrect
class TheClass {
private HashMap map;
void addEntry(Object key, Object value) {
// map has never been initialized, so the next
// line will throw a NullPointerException
map.put(key, value);
}
}

### JAVA0096

### Field in Nested Class Hides Outer Field

It is potentially confusing to create a field in a nested class that has the same name as a visible field in an outer class.

### JAVA0098

### Minimize Use of Implicit Field Initializers

Java implicitly initializes all fields to default values. However, code can be made clearer if one explicitly initializes all fields to appropriate values, even when those values are the same as the defaults. This rule is only reported if a class has two or more non-private and non-final fields, none of which have initializers.

### Example

// Correct
class TheClass( ) {
int count = 0;
int total = 0;
...
}
// Incorrect
class TheClass( ) {
int count;
int total;
...
}

### JAVA0100

### Class Contains N Non-Final Fields

### Maximum: M

A class with a large number of non-final fields may be difficult to understand.

Configuration: Enerjy Code Analyzer can be configured for the number of allowable non-final fields. The default is 8.

### JAVA0101

### Unnecessary Modifier for Field in Interface

Every field in an interface is implicitly public, static and final. There is no need to explicitly specify these modifiers.

### Example

// Correct
interface IAnalyzable {
int MODE = 1;
}
// Incorrect
interface IAnalyzable {
public static final int MODE = 1;
}

### JAVA0102

Last Statement in Finalize( ) not Super.Finalize( )

Every finalize method should end with a call to super.finalize( ) to ensure that the base type is properly finalized. This is good practice even for classes that inherit directly from java.lang.Object because inheritance hierarchies change over time and it is easy to forget to return to the finalize( ) method to add this statement. See Java Language Specification 12.6.

### JAVA0103

### Explicit Call to Finalize( )

Explicit invocation of an object's finalize( ) method does not change its finalized state as far as the Java Virtual Machine (JVM) is concerned. The finalize( ) method will be called again once the object is no longer reachable. See Java Language Specification 12.6.1.

### JAVA0104

### Finalize( ) Only Calls Super.Finalize( )

A finalize method that only calls super.finalize( ) is unnecessary and can be removed.

### Example

// Correct
class TheClass {
...
}
// Incorrect
class TheClass {
...
public void finalize( ) throws Throwable {
super.finalize( );
}
}

### JAVA0105

### Duplicate Import Declaration

A duplicate import statement serves no purpose and should be removed. These duplicates are often created as code evolves and a maintenance programmer fails to notice that a type or package has already been imported. This is especially likely if import statements are not maintained in sorted order (see rule JAVA0005—Imports not in specified order). It is not an error to import both a package and specific type within that package because this is sometimes necessary to resolve ambiguity.

### Example

// Correct
import java.util.*;
import mypackage.*; // assume mypackage contains a type
// called List
import java.util.List; // ok - List means
// java.util.List, not mypackage.List
// Incorrect
import java.util.*;
import mypackage.*;
// lots of other imports
...
// duplicate import
import java.util.*;

### JAVA0106

### Unnecessary Import from Current Package

Other types in the same package are automatically available. There is no need to explicitly import them. An on-demand import from the current package is ignored. (See Java Language Specification 7.5.2) A single-type import is allowed but serves no purpose. (See Java Language Specification 7.5.1)

### Example

// Incorrect
package com.enerjy;
// unnecessary import from current package
import com.enerjy.*;
// Incorrect
package com.enerjy;
// unnecessary import from current package
import com.enerjy.Analyzer;

### JAVA0108

### Incorrect Javadoc

### No @Param Tag for ‘Parameter’

Documentation comments (javadoc) should contain an @param tag for every method parameter, to explain the purpose of the parameter and any restrictions on input values. This rule will not check for method overrides.

### Example

// Correct
/**
* Registers the text to display in a tool tip.
* The text displays when the cursor lingers over
* the component.
* @param text The string to display. If the text
* is null, the tool tip is turned off for this
* component.
*/
public void setToolTipText(String text)

In the following code, there is no documentation for a text parameter.

// Incorrect
/**
* Registers the text to display in a tool tip.
* The text displays when the cursor lingers over
* the component.
*/
public void setToolTipText(String text)

### JAVA0109

### Incorrect Javadoc

### No Parameter ‘Parameter’

A parameter is described in an @param tag in a documentation comment, but no such parameter exists. This usually happens when a parameter is removed from a method but the corresponding comment is not updated. The documentation comment should be updated.

### Example

// Correct
/**
* Registers the text to display in a tool tip.
* The text displays when the cursor lingers over
* the component.
* @param text The string to display. If the text
* is null, the tool tip is turned off for this
* component.
* @param textColor The color for the text, taken
* from the TextColors enumeration.
*/
public void setToolTipText(String text, int textColor)

In the following code, the textColor parameter has been removed from the method, but the comment remains.

// Incorrect
/**
* Registers the text to display in a tool tip.
* The text displays when the cursor lingers over
* the component.
* @param text The string to display. If the text
* is null, the tool tip is turned off for this
* component.
* @param textColor The color for the text, taken
* from the TextColors enumeration.
*/
public void setToolTipText(String text)

### JAVA0110

### Incorrect Javadoc

### No @Return Tag

Documentation comments (javadoc) should contain an @return tag for every non-void method describing the return value. This rule will not check for method overrides.

### Example

// Correct
/**
* Returns the number of words read so far.
* @return The number of words read.
*/
public int getReadWords( )
There is no @return tag in the following code.
// Incorrect
/**
* Returns the number of words read so far.
*/
public int getReadWords( )

### JAVA0111

### Incorrect Javadoc

### @Return Tag for Void Method

A return value is described in the @return tag of documentation comment (javadoc) for a void method or constructor; but such methods cannot have return values. The documentation comment should be updated.

### Example

// Correct
/**
* Registers the text to display in a tool tip.
* The text displays when the cursor lingers over
* the component.
* @param text The string to display.
* If the text is null, the tool tip is turned off
* for this component.
* @return The previous tooltip text.
*/
public String setToolTipText(String text)

In the following code, the void method does not have a return value.

// Incorrect
/**
* Registers the text to display in a tool tip.
* The text displays when the cursor lingers over
* the component.
* @param text The string to display.
* If the text is null, the tool tip is turned off
* for this component.
* @return The previous tooltip text.
*/
public void setToolTipText(String text)

### JAVA0112

### Incorrect Javadoc

### No Exception ‘Exception’ in Throws

An exception is described in an @exception or @throws tag (the two are synonymous) in a documentation comment; but the exception is not specified in the method's throws clause. This usually happens when an exception is removed from a method but the corresponding comment is not updated. The documentation comment should be updated.

Note: This rule applies to checked exceptions only. It is common to document unchecked exceptions that a method explicitly throws, but it is considered bad style to include those unchecked exceptions in the throws clause.

### Example

In the following code, illegalArgumentException is an unchecked exception and can appear in the doc without being listed in the throws clause.

// Correct
/**
* Reads the specified number of characters from
* the input stream
*
* ...
* @throws java.io.IOException Reading the input
* stream failed.
*/
public void read(InputStream in, int charsToRead) throws IOException

in the following code, java.text.ParseException is a checked exception that is not listed in the throws clause; so the doc is wrong.

// Incorrect
/**
* Reads the specified number of characters from
* the input stream
*
* ...
* @throws java.io.IOException Reading the input
* stream failed.
* @throws java.lang.IllegalArgumentException
*/
public void read(InputStream in, int charsToRead) throws IOException
// Incorrect
/**
* Reads the specified number of characters from
* the input stream
*
* ...
* @throws java.io.IOException Reading the input
* stream failed.
* @throws java.text.ParseException
*/
public void read(InputStream in, int charsToRead) throws IOException

### JAVA0113

### Incorrect Javadoc

### No @Author Tag

The documentation comment (javadoc) for a class or interface does not contain an @author tag.

### Example

// Correct
/**
* An Attr object defines an attribute as a name/value
* pair, where the name is a String and the value an
* arbitrary Object.
* @author Plato
*/
There is no @author tag in the following code.
// Incorrect
/**
* An Attr object defines an attribute as a name/value
* pair, where the name is a String and the value an
* arbitrary Object.
*/

### JAVA0114

### Incorrect Javadoc

### No @Version Tag

The documentation comment (javadoc) for a class or interface does not contain an @version tag.

### Example

// Correct
/**
* An Attr object defines an attribute as a name/value
* pair, where the name is a String and the value an
* arbitrary Object.
* @version 1.1
*/
There is no @version tag in the following code.
// Incorrect
/**
* An Attr object defines an attribute as a name/value
* pair, where the name is a String and the value an
* arbitrary Object.
*/

### JAVA0115

### Incorrect Javadoc

### No @Throws or @Exception Tag for ‘Exception’

Documentation comments (javadoc) should contain an @exception or @throws tag (the two are synonymous) for every exception that the method is declared to throw. This rule will not check for method overrides.

### Example

// Correct
/**
* Reads the specified number of characters from the
* input stream
* ...
* @throws java.io.IOException Reading the input
* stream failed.
*/
public void read(InputStream in, int charsToRead) throws IOException
There is no @throws tag in the following code.
// Incorrect
/**
* Reads the specified number of characters from
* the input stream
* ...
*/
public void read(InputStream in, int charsToRead) throws IOException

### JAVA0116

### Missing Javadoc

### Field ‘Field’

One should provide documentation comments (javadoc) for all fields in a type.

Configuration: Enerjy Code Analyzer can be configured to specify that javadoc is only required for fields with certain access levels. For example, public fields only. However, consider documenting all fields so that one can use javadoc to generate internal documentation, not just documentation for external users of one's class.

### Example

// Correct
...
/**
* The number of words read so far
*/
private int readWords = 0;
// Incorrect
...
private int readWords = 0;
...

### JAVA0117

### Missing Javadoc

### Method ‘Method’

Documentation comments (javadoc) should be provided for all methods in a type.

Configuration: Enerjy Code Analyzer can be configured to specify that javadoc is only required for methods with certain access levels. For example, public methods only. However, consider documenting all methods so that one can use javadoc to generate internal documentation, not just documentation for external users of one's class.

### Example

// Correct
...
/**
* Returns the number of words read so far
* ...
*/
private int getReadWords( ) {
...
}
// Incorrect
...
private int getReadWords( ) {
...
}
...

### JAVA0118

### Missing Javadoc

### Type ‘Type’

Documentation comments (javadoc) for all classes and interfaces should be provided.

Configuration: Enerjy Code Analyzer can be configured to specify that javadoc is only required for types with certain access levels. For example, public types only. However, consider documenting all types so that one can use javadoc to generate internal documentation, not just documentation for external users of one's class.

### Example

// Correct
...
/**
* A position object maintains information about the location where
* an error occurred.
* ...
*/
private class Position {
...
}
// Incorrect
...
private class Position {
...
}
...

### JAVA0119

### Control Variable Changed within Body of for Loop

Variables used in the conditional expression of a for loop should only be modified in the update expression of that for loop. Changing the value of these variables within the body of the for loop can adversely affect maintenance and readability of code. Instead, move statements that update the value to the update expression of the for loop or change the loop to a while loop.

### JAVA0123

### Use all Three Components of for Loop

If one is not using the initialization, test and update parts of a for loop, a while loop is probably more appropriate.

### Example

// Correct
// All three parts used
for (int i = 0 ; i < 3 ; ++i) {
...
}
// Correct
while (i < 3) {
...
++i;
}
// Incorrect
The while loop above is clearer
for ( ; i < 3 ; ++i) {
}

### JAVA0125

### Continue Statement with Label

Labeled continue statements are GOTOs by another name. Like with GOTO, they occasionally lead to clearer code, but usually add no value and should be removed.

### JAVA0126

### Method Declares Unchecked Exception in Throws

A method or constructor's throws clause should list only the checked exceptions that the method can throw. It is good practice to document unchecked exceptions that the method explicitly throws (see rule JAVA0112—Incorrect javadoc: no exception ‘exception’ in throws); but these exceptions should not be listed in the throws clause.

### Example

IllegalArgumentException is an unchecked exception and should appear in the doc without being listed in the throws clause.

// Correct
/**
* Reads the specified number of characters from the
* input stream
*
* ...
* @throws java.io.IOException Reading the input
* stream failed.
* @throws java.lang.IllegalArgumentException
* charsToRead is negative
* or supplied inputstream
* is invalid
*/
public void read(InputStream in, int charsToRead) throws IOException

illegalArgumentException is an unchecked exception and should not appear in the throws clause.

// Incorrect
/**
* Reads the specified number of characters from the
* input stream
*
* ...
* @throws java.io.IOException Reading the input stream
* failed.
* @throws java.lang.IllegalArgumentException
* charsToRead is negative
* or supplied inputstream
* is invalid
*/
public void read(InputStream in, int charsToRead)
throws IOException, IllegalArgumentException

### JAVA0128

### Public Constructor in Non-Public Class

There is no value in providing a public constructor because a non-public class cannot be instantiated outside the package in which it is defined. Reduce the access of the constructor to match that of the class itself.

### Example

// Correct
public class TheClass {
public TheClass( ) {
}
}
// Correct
class TheClass {
TheClass( ) {
}
}
// Incorrect
class TheClass {
// Public constructor in non-public class.
public TheClass( ) {
}
}

### JAVA0130

### Non-Static Method does not Use Instance Fields

A method that does not use any instance fields can be declared static. This makes the method more useful since it is not necessary to have an object instance available in order to call it.

### Example

// Correct
class TheClass {
private int cost;
...
public int getCost( ) {
return cost;
}
}
// Incorrect
class TheClass {
// This method should be static since it doesn't
// use any instance variables
public int getCost( ) {
return 37;
}
}

### JAVA0131

### Compatible Method does not Override Base

A method only overrides a similarly named method in a superclass if it takes exactly the same parameters. If the parameters are compatible but not identical, the method is not overridden. This rule detects such near-overrides because they are often intended to be genuine overrides. Consider changing the parameters to make the method a genuine override or changing the method name to prevent confusion with the superclass method.

### Example

The following code shows a correct override of Object.equals( ).

// Correct
class TheClass {
public boolean equals(Object o) {
...
}
}
In the following code, method does not override Object.equals( ).
// Incorrect
class TheClass {
public boolean equals(TheClass o) {
...
}
}

### JAVA0132

### Method Overload with Compatible Signature

This rule identities methods that have the same name and compatible arguments, such as two methods where one takes a String and the other an Object. While the Java language permits methods declared this way, it can be confusing. Consider a single method that takes a common ancestor, or changing the method names to be more descriptive.

### Example

// Correct
public class TheClass {
void process(Object obj) {
if (obj instanceof String) {
...
}
...
}
}
// Incorrect
public class TheClass {
void process(Object obj) {
...
}
void process(String obj) {
...
}
}

### JAVA0133

### Non-Synchronized Method Overrides Synchronized Method

A synchronized modifier is viewed as an implementation detail and is not inherited. Check to see if one's method override should also be synchronized.

### Example

// Correct
class Base {
private HashMap map = new HashMap( );
public synchronized void addValue(Object key, Object value) {
map.put(key, value);
}
}
class Derived extends Base {
public synchronized void addValue(Object key, Object value) {
map.put(key, value);
doSomethingElse( );
}
}
// Incorrect
class Base {
private HashMap map = new HashMap( );
public synchronized void addValue(Object key, Object value) {
map.put(key, value);
}
}
class Derived extends Base {
// Method not synchronized so map is vulnerable to
// corruption by another thread
public void addValue(Object key, Object value) {
map.put(key, value);
doSomethingElse( );
}
}

### JAVA0135

### Only One of Object.Equals and Object.HashCode Defined

### Missing ‘Method’

For hashtables to work correctly, it is essential that two equal objects have the same hashCode. This is true of the default implementation of equals( ) and hashCode( ) that are provided by java.lang.Object. But if one overrides one of these methods, one must usually override the other in order to maintain this condition.

### Example

// Correct
class TheClass( ) {
private String name;
public boolean equals(Object o) {
if (o.getClass( ) != this.getClass( )) {
return false;
}
TheClass other = (TheClass)o;
return this.name.equals(other.name);
}
public int hashCode( ) {
return name.hashCode( );
}
}
// Incorrect
class TheClass( ) {
private String name;
public boolean equals(Object o) {
if (o.getClass( ) != this.getClass( )) {
return false;
}
TheClass other = (TheClass)o;
return this.name.equals(other.name);
}
}

This class won't work as a key in a HashMap because two different objects with the same name will have different hashCodes.

### JAVA0136

### N Methods Defined in Class

### Maximum: M

A class or interface that defines too many methods can be difficult to understand.

Configuration: Enerjy Code Analyzer can be configured for the allowable number of methods. The default is 20.

### JAVA0137

### Non-Abstract Class Missing Constructor

A non-abstract class should provide a constructor that ensures all fields are initialized to appropriate values before the object is used. Java does provide default values for all fields, but it is considered a bad practice to rely on them. This rule does not apply when explicit initializers are provided for all fields.

### Example

// Correct
class TheClass( ) {
// Methods only. No instance fields so no
// constructor required
}
// Correct
class TheClass( ) {
private int count = 0;
// Methods only. All instance fields are initialized
// so no constructor is required
}
// Incorrect
class TheClass( ) {
private int count;
// Methods only. The field ‘count’ is not explicitly
// initialized, so a constructor is required
}

### JAVA0138

### N Parameters Defined for Method

### Maximum: M

A method that takes too many parameters can be difficult to understand. One solution is to package some of the parameters into a single object and pass the object as a parameter.

Configuration: Enerjy Code Analyzer can be configured for the allowable number of parameters. The default is 5.

### Example

// Correct
class Event {
int type;
String name;
Date time;
int flags;
Point mousePosition;
}
class TheClass {
void processEvent(Event evt) {
}
}
// Incorrect
class TheClass {
void processEvent(int type, String name, Date time, int flags,
int mouseX, int mouseY) {
}
}

### JAVA0139

### Definition of Main Other than Public Static Void Main(Java.Lang.String[ ])

The Java runtime looks for a method with the signature public static void main(String[ ]) when it launches a Java class. The name main should be reserved for this method only.

### Example

// Correct
class TheClass {
public static void main(String[ ] args) {
System.out.println(“Hello, world”);
}
}
// Incorrect
class TheClass {
// Not a ‘main’ method - no String[ ] parameter
public static void main( ) {
System.out.println(“Hello, world”);
}
}

### JAVA0141

### Unnecessary Modifier for Method in Interface

Every method in an interface is implicitly abstract and public. There is no need to provide these modifiers.

### Example

// Correct
interface IAnalyzable {
int getMode( );
}
// Incorrect
interface IAnalyzable {
public abstract getMode( );
}

### JAVA0143

### Synchronized Method

Some developers avoid synchronized methods, preferring to use synchronized statements. This avoids complications like the non-inheritance of the synchronized modifier (see rule JAVA0133—Non-synchronized method overrides synchronized method). It also allows finer control over the choice of object to synchronize on, potentially resulting in improved concurrency.

### Example

// Correct
class Base {
private HashMap map = new HashMap( );
public void addValue(Object key, Object value) {
synchronized(map) {
map.put(key, value);
}
}
}
// Incorrect
class Base {
private HashMap map = new HashMap( );
public synchronized void addValue(Object key, Object value) {
map.put(key, value);
}
}

### JAVA0144

### Line Exceeds Maximum M Characters

Long lines are difficult to read and may not print well.

Configuration: Enerjy Code Analyzer can be configured for the allowable line length. The default is 132.

### JAVA0145

### Tab Character Used in Source File

Tab characters are undesirable in source files because different editors interpret them in different ways and use different default tab widths. It is preferable to use spaces instead of tabs to format source code to ensure that the code looks good in any editor.

### JAVA0150

### Java.Lang.Error (or Subclass) Thrown

Exceptions that are represented by the subclasses of class java.lang.Error are thrown due to a failure in or of the virtual machine. User code should not throw exceptions of this type. The only exception is that one is allowed to rethrow a java.lang.ThreadDeath exception that one has just caught. See Java Language Specification 8.4.6.

### Example

// Correct
try {
...
}
catch (ThreadDeath e) {
...
throw e;
}
// Incorrect
...
throw new OutOfMemoryError( );
...

### JAVA0153

### Inefficient Conversion of Integer to String

Using new Integer(int).toString( ) to convert int values to String values creates a temporary Integer object and is inefficient. Use String.parseInt(int) instead.

### JAVA0159

### Inefficient Conversion of String to Integer

Using Integer.valueOf(String).intValue( ) to convert. String values to int values creates a temporary Integer object and is inefficient. It is preferable to instead use Integer.parseInt(java.lang.String).

### JAVA0160

### Method does not Throw Specified Exception

The throws clause of a method should list only those checked exceptions that can be thrown from that method. This rule identifies exceptions that are specified in the method declaration but are not explicitly thrown by itself or other methods it calls.

### JAVA0161

### Conditional Wait( ) not in Loop

Another thread may negate the wait condition while this thread competes to reacquire the lock. Use a while loop to force a check of the wait condition after the lock is acquired.

### JAVA0163

### Empty Statement

Semicolons immediately following an if, for, or while statement are easily missed and represent an empty statement for the condition or loop. If an empty statement is required, use curly braces and a comment to identify intent.

### JAVA0165

### Conflicting Return Statement in Finally Block

Code in a finally block is always executed. A return statement in a finally block will always override any return statement in a try or catch block. This is unlikely to be the desired behavior. The following code always returns true because the return statement in the finally block overrides the return statement in the try block.

### Example

// Correct
try {
...
while (i < 3) {
if (problemsFound) {
break;
}
...
}
}
finally {
...
return true;
}
// Incorrect
try {
...
while (i < 3) {
if (problemsFound) {
return false;
}
...
}
}
finally {
...
return true;
}

### JAVA0166

### Generic Exception Caught

The four exception types—java.lang.Throwable, java.lang.Exception, java.lang.RuntimeException and java.lang.Error—are generic. Unless one is trying to prevent exceptions from escaping from a block of code, it is dangerous to catch one of these types because one may accidentally be handling an exception of a type that one had not anticipated. It is safer to identify the individual types that can occur and handle them individually.

### Example

// Correct
try {
...
}
catch (NullPointerException e) {
...
}
catch (IndexOutOfBounds e) {
...
}
// Incorrect
try {
...
}catch (RuntimeException e) {
...
}

### JAVA0167

### ThreadDeath not Rethrown

A java.lang.ThreadDeath exception is thrown when a thread is terminated using the deprecated Thread.stop( ) method. If one catches this exception in the target thread and does not rethrow it, the thread will not terminate. One should rewrite the code so that it does not use Thread.stop( ) and ThreadDeath.

### JAVA0169

### Unnecessary Catch Block

### Exception ‘Exception’

A catch block that simply rethrows the caught exception is not necessary and can be removed. The only exception to this rule is if one has a later catch block that would also catch the exception and one wants to prevent a particular exception from reaching that block.

### Example

// Correct
try {
...
}
// we want to propagate NullPointerExceptions to the
// caller
catch (NullPointerException e) {
throw e;
}
// all other exceptions get the default handling
catch (RuntimeException e) {
// Default handling for runtime exceptions
...
}
// Incorrect
try {
...
}
// No need for this catch block
catch (NullPointerException e) {
throw e;
}

### JAVA0170

### Caught Exception not Derived from Java.Lang.Exception

Exceptions that are represented by the subclasses of class java.lang.Error are thrown due to a failure in or of the virtual machine. Unless one knows exactly what one is doing, it is dangerous to try and handle these. Usually, one should only handle exceptions that derive from java.lang.Exception.

### JAVA0171

### Unused Local Variable

A local variable that is unused is potentially confusing and should be removed. They usually arise when code is modified, making the variable no longer necessary; but the initial declaration is not removed. In the following code, the variable j is unused.

### Example

// Correct
{
int j = 0;
for (int i = 0 ; i < 5 ; ++i) {
++j;
}
}
// Incorrect
{
int j = 0;
for (int i = 0 ; i < 5 ; ++i) {
// Other code, not referencing j
}
}

### JAVA0173

### Unused Method Parameter

A method parameter that is unused is potentially confusing and should be removed. This rule does not apply if the method is an override, because the method signature is determined by the superclass or superinterface. In this case, the parameter cannot be removed.

### Example

// Correct
class Base {
void doSomething(String failMessage) {
// Do something, printing failMessage if it goes
// wrong
}
}
case Derived {
void doSomething(String failMessage) {
// Do something that can't go wrong. We never need
// failMessage, but we can't remove it because
// then we won't override doSomething( ) in Base
}
}

### JAVA0174

### Assigned Local Variable Never Used

An assignment to a local variable that is never subsequently used is unnecessary and potentially confusing. This rule only applies if there is no possible code path that uses the variable—the value does not have to be used on every code path. This rule also excludes initializers, because a local variable that is initialized and then never used is detected by rule JAVA0171—Unused local variable.

### Example

// Correct
int i;
i = 3;
if (j < 3) {
// do something involving i
}
else {
// do something not involving i
}

### JAVA0175

### Successive Assignment to Variable

An assignment to a local variable that is followed by another assignment is unnecessary and potentially confusing. This rule only applies if all possible code paths write to the variable without first reading it. This rule also excludes initializers because it is good practice to always initialize local variables to simple default values even if those values will all be overwritten at some point. In the following code, the second assignment to ‘i’ is conditional and might not be executed. In the following code, initializers are excluded. In the following code, the ‘i=0’ assignment is never used and should be removed.

### Example

// Correct
int i;
i = 0;
i (j< 3) {
i = 1;
}
System.out.println(i);
// Correct
int i = 0;
...
if (j < 3) {
i = 1;
}
else {
i = 2;
}
// Incorrect
int i;
i = 0;
// other code not using i
if (j < 3) {
i = 1;
}
else {
i = 2;
}

### JAVA0176

### Local Variable Name does not have Required Form

Naming conventions can enhance the readability of code and form part of the documented coding standards in many organizations. This rule helps ensure that local variable names comply with one's standards.

Configuration: Enerjy Code Analyzer can be configured for allowable names. The default is for the name to begin with a letter followed by letters, digits or underscores.

### JAVA0177

### Variable Declaration Missing Initializer

It is good practice to provide initializers for all local variables. In the following code, there is no initializer for i.

### Example

// Correct
void doSomething( ) {
int i = 0;
...
}
// Incorrect
void doSomething( ) {
int i;
...
}

### JAVA0179

### Local Variable Hides Visible Field

It is potentially confusing for a local variable to have the same name as a visible field. For example, it is easy to introduce a bug by forgetting to use this. to refer to the field.

### Example

// Incorrect
private int value;
void doSomething( ) {
int value = 0;
...
// Oops, wanted to print the instance variable value,
// not the local variable
System.out.println(“this.value == “ + value);
}

### JAVA0233

### Definition of SerialVersionUID Other than ‘Private Static Final Long SerialVersionUID’

Sun's Java 5.0 API documentation states, “It is also strongly advised that explicit serialVersionUID declarations use the private modifier where possible, because such declarations apply only to the immediately declaring class—serialVersionUID fields are not useful as inherited members” This rule only applies if the class is serializable.

### JAVA0234

### Class is Serializable but does not Define SerialVersionUID

A class that is serializable should define a serialVersionUID.

### JAVA0235

### Class Defines SerialVersionUID but does not Implement Serializable

While serialVersionUID is not a reserved word, it is customary to use this variable for classes that implement the serializable interface.

### JAVA0236

### Attempt to Clone an Object which does not Implement Cloneable

This should cause a CloneNotSupportedException to be thrown, because the object's class does not support the cloneable interface.

### JAVA0237

### Class Implements Cloneable but does not have Public Clone Method

Sun's Java documentation on Cloneable states, “By convention, classes that implement this interface should override Object.clone( ) (which is protected) with a public method. See Object.clone( ) for details on overriding this method.”

### JAVA0238

### Clone Method does not Call Super.Clone( )

Sun's Java documentation on Object.clone( ) states, “By convention, the returned object should be obtained by calling super.clone.”

### JAVA0239

### Class Declares ‘ReadObject’ or ‘WriteObject’ but does not Implement Serializable

Classes that require special handling during the serialization and deserialization process must implement special methods with these exact signatures:

private void writeObject(java.io.ObjectOutputStream out) throws IOException;

private void readObject(java.io.ObjectInputStream in) throws IOException,
ClassNotFoundException;

Classes that do not implement Serializable should not include these methods.

### JAVA0240

### Serializable Class which Declares ReadObject or WriteObject but not Both

The writeObject method is responsible for writing the state of the object for its particular class, so that the corresponding readObject method can restore it. A Serializable class that has a readObject method should also have a writeObject method.

### JAVA0241

### ‘ReadObject’ or ‘WriteObject’ should be Declared Private in Serializable Class

Classes that require special handling during the serialization and deserialization process must implement special methods with these exact signatures:

private void writeObject(java.io.ObjectOutputStream out) throws IOException;

private void readObject(java.io.ObjectInputStream in) throws IOException,
ClassNotFoundException;

These methods private should be declared private.

### JAVA0242

### Transient Field in Non-Serializable Class

The transient keyword is used to denote nonserializable fields, so it is unnecessary for classes that do not implement the Serializable interface.

### JAVA0243

‘ReadResolve’ or ‘WriteReplace’ should be Declared Private or Protected

The readResolve and writeReplace methods are called by the serialization system, and should not be accessible in any other context.

### JAVA0244

### Field or Method Name in Subclass Differs Only by Case from Inherited Field or Method

It is potentially confusing for a method or field name to differ from that in a superclass or interface only by capitalization. In many cases, this is a typographical error; in all other cases it is confusing code.

### Example

When overriding the junit.framework.TestCase.tearDown( ); method in a subclass.

class MyClass extends junit.framework.TestCase {
// Incorrect
// The following is not an override
protected void teardown( ) { }
// Correct
// This is an override
protected void tearDown( ) { }
}

### JAVA0245

### JUnit TestCase with Non-Trivial Constructor

Initialization logic for a JUnit TestCase should be in the setUp( ) method rather than in the constructor.

### JAVA0246

### JUnit AssertXXX Statement Missing Message Parameter

The message parameter is displayed when an assert fails. Pass in a message to make one's test more informative.

### JAVA0247

### JUnit ‘SetUp( )’ and ‘TearDown( )’ should Call Super Method

This rule ensures that when one subclasses a TestCase, the superclass(es) will be properly initialized.

### JAVA0248

### JUnit Method ‘SetUp’ and ‘TearDown’ with Incorrect Signature

These methods must override the ones in the junit.framework.TestCase class, or they will not be called by the JUnit framework.

### JAVA0249

### JUnit TestCase ‘Suite( )’ should be Declared Static

JUnit provides different test runners that can run a test suite and collect the results. A test runner either expects a static method suite as the entry point to get a test to run or it will extract the suite automatically.

### JAVA0250

### JUnit TestCase Declares TestXXX Method with Incorrect Signature

The JUnit framework uses reflection to implement runTest. It dynamically finds and invokes a method based on a simple convention that test methods that begin with the prefix test and take no arguments. If a method in a TestCase does not exactly follow this convention, the test will not be executed.

### JAVA0251

### Use ‘% n’ for Line Breaks in Printf/Format for Platform Independence

As of 5.0, Java has a string formatting facility similar to printf in C. One of the format codes is “% n”, which lets one to specify a line break without worrying about platform differences. If one uses “\n” or “\r” in a format string, it is suggested that one use “% n” instead.

### JAVA0252

### ‘Enum’ is a Java 1.5 Reserved Word

To avoid issues when migrating to Java 5.0, avoid the word “enum” as it is a Java 5.0 reserved word.

### JAVA0253

### Not all Enum Constants Consumed in Switch Statement

As of Java 5.0, one can make a switch/case statement using an Enumerated type. This rule fires if the switch statement does not consume all of the constants declared in the enum. This rule does not fire if one has a default case in one's switch statement, because it will consume any constants not handled elsewhere.

### Example

public enum Command {
CMD_QUIT,
CMD_HELP_TWO,
CMD_RUN;
}
public void doCmd (Command cmd) {
switch(arg) {
case CMD_QUIT:
...
break;
case CMD_HELP:
...
break;
//CMD_RUN not consumed
}
}

### JAVA0254

### Use Enhanced for Loop Construct Instead of Iterator

The Java 5.0 enhanced for loop should be used instead of an iterator when one wants to iterate over all of the elements of a Collection. One cannot use this if one needs access to the iterator within the body of the loop (for example, if one needs to call Iterator.remove( )).

### Example

// Old loop
Iterator iter = strings.iterator( ):
while (iter.hasNext( )) {
String item = (String)iter.next( );
System.out.println(item);
}
// New loop
for (String item : strings) {
System.out.println(item);
}

### JAVA0255

### Result of Method Invocation not Used

To configure this rule, one must specify a list of types that one is interested in (for example, types that are immutable). The rule will fire whenever the return from a method call on an instance of one of the specified rules is not used. Because String is immutable, it makes no sense to call toLowerCase( ) unless one plans to use the return value.

Configuration: The rule can be configured with the list of types that will be checked to ensure callers use the return value of methods that return the same type.

### Example

String aString=new String(“Value”);

aString.toLowerCase( );

### JAVA0256

### Assignment of External Collection/Array to Field

Assigning a collection or array from a method parameter to a field exposes that field to modification from outside the class. Such modification will alter the state of the object, causing unexpected behavior.

Configuration: Enerjy Code Analyzer can be configured to allow assigning collection or array parameters in methods of certain access levels. By default, all methods are flagged.

### JAVA0257

### Use of ‘Constant Interface’ Anti-Pattern

The use of the Constant Interface anti-pattern pollutes the public API with implementation details. See Effective Java, chapter 17 for more information on why the Constant Interface anti-pattern is not recommended.

### JAVA0258

### Implement Iterable for Foreach Compatibility

Java 5.0 introduced an enhanced form of the for loop. In order for a collection type to be usable in the enhanced for loop, it must implement the Iterable interface. This rule fires on types that declare methods that return an Iterator, but do not implement Iterable.

### Example

ArrayList<String> aList = new ArrayList<String>( );
...
for (String t : aList){
System.out.println(t);
}

### JAVA0259

### Return of Collection Array Field

Returning a collection or array field from a method exposes that field to modification from outside the class. Such modification will alter the state of the object, causing unexpected behavior.

Configuration: Enerjy Code Analyzer can be configured to allow returning collection or array fields from methods of certain access levels. By default, only private methods are ignored.

### JAVA0260

### Use ‘Enum’ Instead of Enumerated Type Pattern

The introduction of the new enum type in Java 5.0 renders use of the Enumerated Type pattern unnecessary. Use of the new enum type has a number of advantages over the Enumerated Type pattern, including the ability to be used directly in switch/case statements.

### JAVA0261

### Use specialized Enum Collection Types

Java 5.0 contains two specialized collection types for use with Enumerated types: EnumMap and EnumSet. The use of these collections is more efficient than creating a regular Map or Set collection with an Enumerated Type.

### JAVA0262

### Use of Char in Integer Context

This rule fires whenever a char parameter is passed to a method that is expecting an int parameter in that position.

Configuration: One can configure this rule to ignore methods called on particular types. By default, this rule ignores methods called on java.lang.String, java.io.OutputStream and java.io.Writer.

### Example

StringBuffer buffer=new StringBuffer(‘c’);

The above example does not create a new StringBuffer containing the character ‘c’. It creates a new empty StringBuffer with an initial size of 99 (the int value of char). The conversion from char to int is silent.

### JAVA0263

### Long Literal Ends with ‘l’ Instead of ‘L’

This rule fires when one uses a long literal that ends with ‘l’ (lower case L). This practice is not recommended because ‘l’ looks too similar to ‘1’. Use ‘L’ instead.

### Example

Long value=5432l;

### JAVA0264

### Integer Math in Long Context

### Check for Overflow

This rule will tire when integer math is used in the long context. The result of the following calculation will not be the expected one, because the result is larger than the maximum int value. The calculation can be forced into long context by making the first literal a long.

### Example

public static final long MICROS=24*60*60*1000*1000;

public static final long MICROS=24L*60*60*1000*1000;

### JAVA0265

### Use of Throwable.PrintStackTrace( )

The use of Throwable.printStackTrace( ) may indicate residual auto-generated or boilerplate code.

### Example

try {
writer.write(‘a’);
}
catch (IOException e) {
// TODO Auto-generated catch block
e.printStackTrace( );
}

### JAVA0266

### Use of System.Out

The use of System.out may indicate residual debug or boilerplate code.

### JAVA0267

### Use of System.Err

The use of System.err may indicate residual debuts or boilerplate code. Consider using a full-featured logging package such as Apache Commons to handle error logging.

### JAVA0269

### Contents of StringBuffer Never Used

This rule fires when a StringBuffer variable is declared and manipulated, but the contents of the StringBuffer are never used.

### Example

public void aMethod(int value){
StringBuffer buffer = new StringBuffer( );
buffer.append(“The value is;”);
buffer.append(value);
// Oops, We didn't do anything with buffer.
}

### JAVA0270

### Use Java 5.0 Enhanced for Loop Construct to Iterate Over all Elements in an Array

Use the Java 5.0 enhanced for loop instead of a for loop that iterates over all elements in an array. See:
http://java.sun.com/j2se/1.5.0/docs/guide/language/foreach.html.

### Example

// given a String array
String[ ] items;
// Old style
for(int i=0; i<items.length; ++i) {
// do something with each item
items[i];
}
// New style
for(String item ; items) {
//do something with each item
item;
}

### JAVA0271

### Minimize Use of on-Demand (.*) Static Imports

Multiple on-demand import statements can clutter one's namespace, making it difficult to figure out which class a static member comes from. These statements can also be difficult to read when different classes have static members with the same identifier (for example, java.awt.BorderLayout.CENTER, java.awt.FlowLayout.CENTER, and java.awt.GridBagConstraints.CENTER).

Configuration: Enerjy Code Analyzer can be configured with the number of on-demand static imports to allow before firing this rule. The default value is 2.

### Example

// Correct
// The java.lang.Math package is a good candidate for
// on-demand static import as it allows one to eliminate
// a lot of explicit references to the Math class when
// using static methods such as cos and static fields
// such as PI
import static java.lang.Math.*;
// Incorrect
// The following three static on-demand imports could
// make one's code difficult to read
// BorderLayout has 13 static fields, FlowLayout has 5,
// and GridBagConstraints has 23.
// There are 11 common static field names in these three
// classes.
import static java.awt.BorderLayout.*;
import static java.awt.FlowLayout.*;
import static java.awt.GridBagConstraints.*;

### JAVA0272

### Thread.Run( ) Called

Explicitly calling run( ) on a Thread object is usually a mistake. If one wants to start the thread, call start( ) instead.

### Example

public void aMethod( ){
Thread thread = new Thread( ) {
public void run( ) {
//Thread does some work here
}
};
thread.run( );
// Oops - thread was never started.
}

### JAVA0273

### Non-Final Derivative of Thread Calls Start( ) in Constructor

Calling start( ) in the constructor of a Thread derivative may cause problems if the type is ever subclassed. In that case, the subclass would not have finished initializing before start( ) is called.

### Example

public class MyThread extends Thread {
public MyThread( ){
start( );
// This will be called before a subclass is
// finished initializing
}
}

### JAVA0274

### Serializable Class has a Synchronized ReadObject( )

It is unnecessary to declare readObject synchronized because object serialization guarantees this object will only be reachable by one thread.

### JAVA0275

### Serializable Class has a Synchronized WriteObject( ) and No Other Synchronized Methods

Because writeObject is meant to be called only when an object is being serialized, writeObject need not be synchronized if no other methods in this class are synchronized.

### JAVA0276

### Unnecessary Use of String Constructor

The java.lang.String(String) constructor makes a copy of the given String. This wastes memory because String objects are immutable. Simply use the argument instead. Similarly, the java.lang.String( ) constructor creates an empty String. This wastes memory because Java guarantees identical String constants (in this case, the constant “ ”) will be represented by the same String object. Simply use “ ” instead.

### JAVA0277

### Iterator.Next( ) Implementation does not Throw NoSuchElementException

When implementing an Iterator, it is good practice to throw a NoSuchElementException if the next( ) method is called and there is no next element.

### Example

public Object next( ) {
if (!hasNext( )){
throw new NoSuchElementException( );
}
return null;
}

### JAVA0278

### Unnecessary use of Boolean Constructor

Using the java.lang.Boolean(boolean) or java.lang.Boolean(String) constructors wastes memory because Boolean can have only one of two values and is immutable. Use Boolean.valueOf (boolean) or Boolean.valueOf(String) to obtain the appropriate Boolean.TRUE or Boolean.FALSE constant instead.

### JAVA0279

### Serialization Method ReadObject or ReadObjectNoData Calls an Overridable Method

Calling an overridable method from within a readObject or readObjectNoData method may result in the unintentional invocation of a subclass method before the superclass has been fully initialized.

### Example

//This class calls an overridable method, initialize( ),
// from its readObject method.
//This could be fixed by declaring the class or the
// initialize method final
public class BadExample implements java.io.Serializable {
protected void initialize( ) {
//do some object initialization code
}
}
private void readObject(ObjectInputStream stream) throws IOException,
ClassNotFoundException
{
initialize( );
}
}

### JAVA0280

### IllegalMonitorStateException Caught

IllegalMonitorStateException is thrown when a thread attempts call wait( ) or notify( ) on a monitor without holding a lock on that monitor. Because this indicates a serious design error, catching IllegalMonitorStateException is not recommended.

### Example

try {
monitor.wait( );
}
catch(IllegalMonitorStateException e) {
// Exception handling here - better to let this
// exception go all the way to the top
}

### JAVA0281

### Iterator.Next( ) not Called in Loop

This rule flags for loops and while loops that use an Iterator in the conditional statement, but do not call Iterator.next( ) within the body of the loop, which most likely results in an infinite loop.

### Example

//this while loop calls Iterator.hasNext in the
// conditional statement, but doesn't call
// Iterator.next in the body of the loop.
Collection c;
Iterator iter = c.iterator( );
while(c.hasNext( )) {
//do something
}

### JAVA0282

### Call to Iterator.Next( ) in Loop which does not Test Iterator.HasNext( )

A call to next( ) on an iterator within a loop that does not call hasNext( ) in its condition expression could result in a runtime exception.

### Example

// Incorrect
Iterator iter1 = c1.iterator( );
while(iter1.hasNext( )) {
Iterator iter2 = c2.iterator( );
while(iter2.hasNext( )) {
// call to iter1.next( ) throws
// NoSuchElementException
Object obj1 = iter1.next( );
Object obj2 = iter2.next( );
// do something with obj1 and obj2
}
}
// Correct
Iterator iter1 = c1.iterator( );
while(iter1.hasNext( )) {
Object obj1 = iter1.next( );
Iterator iter2 = c2.iterator( );
while(iter2.hasNext( )) {
Object obj2 = iter2.next( );
// do something with obj1 and obj2
}
}
// Correct using Java 5.0 For-Each loop
for(Object obj1 : c1) {
for(Object obj2 : c2) {
// do something with obj1 and obj2
}
}

### JAVA0283

### Control Variable not Updated in Loop Body

This rule catches cases where a variable that controls a loop is not updated within the body of the loop, possibly causing the loop to spin endlessly. This can easily happen when converting between for and while loops, or with a complex series of nested loops.

### Example

while (node != null){
if (node.getType( ) == Node.EXPRESSION){
// do some work with node here
}
getParent(node);
// Oops, we never assigned a new value to ‘node’,
// the loop will spin.
}

### JAVA0284

### Explicit Garbage Collection

Code that explicitly invokes the garbage collector, via calls to System.gc( ), should only be used for benchmarking.

### JAVA0285

### Dereference of Potentially Null Variable

This rule detects attempts to dereference a local variable that may be null. Local variables and parameters are assumed to be non-null and thus safe to dereference unless (a) There is a code path in the method that assigns them to null; or (b) the method tests the variable to see if it is null.

### Example

public class Example {
private void aMethod(Object o) {
if (o == null) {
// do something
}
// The following dereference is unsafe because o may be null
System.out.println(o.toString( ));
}
private void aMethod2( ) {
Object o = null;
if (<somecondition>) {
o = new Object( );
}
// The following dereference is unsafe because o may be null
System.out.println(o.toString( ));
}
private void aMethod3(Object o) {
if (o == null) {
o = new Object( );
}
// The following dereference is safe because o cannot be null
System.out.println(o.toString( ));
}
}

### JAVA0286

### Dereference of Null Variable

This rule detects dereferences of variables that are known to be null and thus will throw a NullPointerException at runtime. These errors are usually the result of a developer using the wrong operator in a logical expression.

### Example

public class Example:
protected boolean aMethod(Object o) {
// If o is null, this will throw a NullPointerException.
// The developer probably meant
// return (o != null && o.hashCode( ) == 3);
return (o == null && o.hashCode( ) == 3);
}
protected boolean aMethod2(Object o) {
// If o is null, this will throw a NullPointerException.
// The developer probably meant
// return (o != null && o.hashCode( ) == 3);
return (o != null || o.hashCode( ) == 3);
}
}

### JAVA0287

### Unnecessary Null Check

This rule detects cases where a local variable is tested against null when we already know whether the variable is null. While these tests have a negligible impact on the program at runtime, they show that the developer does not fully understand the data flow within the current method and are likely to confuse a maintenance programmer.

### Example

public void theMethod(Object o) {
if (o == null) {
o = new Object( );
}
// This test is unnecessary since o must be non-null at this point.
if (o == null) {
System.out.println(o);
}
}
public void theMethod2(Object o) {
if (o == null) {
...
// This test is unnecessary since we know o is null within the body
// of this if statement.
if (o != null) {
...
}
}
}

### JAVA0288

### Inconsistent Null Check

This rule detects situations where a local variable is tested against null after it has been de-referenced. If there is a chance that the variable may be null then the dereference needs to be protected. If instead the variable is known to be non-null then the test is unnecessary. In either case, the code is inconsistent as it stands and suggests that the developer does not fully understand the data flow through the method.

### Example

public void theMethod(Object o) {
// If o may be null then this line may throw a NullPointerException.
System.out.println(o.toString( ));
// If o is definitely not null then this test is unnecessary.
if (o == null) {
System.out.println(o);
}
}

5. DEFS that May be Utilized in an Online or Other Practice of the Invention.

Section 5 sets forth DEFS (definitions) that may be utilized in an online or other practice of the present invention. More particularly, Section 5 sets forth, starting on the following page, the content of HTML pages that can be utilized in connection with an online version of the present invention (and in connection with examples of static analysis violations set forth in the previous Section), such as on a website that provides for the generating of software quality indexes, such as for open source software applications or other software applications. The use of HTML is well known, and those skilled in the art will understand how such HTML content may be utilized in implementing the present invention as described herein.

BLOCK_COMMENT—Number of block comment lines
The number of lines within block comments, i.e., comments that start with /* and end with */. Javadoc comments are not included in this metric; they are counted separately in the DOC_COMMENT metric. Block comments that share lines with other text are excluded from this metric.
   BLOCKS—Number of blocks
The number of blocks in the source file. A block is a (possible empty) list of statements surrounded by curly braces.
   COMMENT_DENSITY—Comment density

The ratio of comment lines to lines of code. This metric is computed using the formula:

COMMENT_DENSITY=COMMENTS/ELOC

COMMENTS—Number of comment lines
The total number of lines that contain only comments. Comments that share lines with other text are excluded from this metric. This metric is computed using the formula:

COMMENTS=LINE_COMMENT+BLOCK_COMMENT+DOC_COMMENT

COMPARISONS—Number of comparison operators
The number of comparison operators in the source file. In addition to the ‘obvious’ comparison operators (<, >, <=, >=, ==, !=), this also includes Boolean expressions used as the test in a loop or conditional statement where there is an implicit comparison against true. For example, the snippet while(it.hasNext( )) contributes a count of 1 to the metric as it is equivalent to while(it.hasNext( )==true).
   CYCLOMATIC—Cyclomatic complexity
The total McCabe Cyclomatic Complexity for all of the methods in the source file. The definition of cyclomatic complexity for a method is complex, but the basic idea is to measure the number of independent paths through that method. Although the actual algorithm that Enerjy uses is sophisticated, one can approximate the cyclomatic complexity for a method by starting with 1 and simply incrementing the value for each loop and if statement.
   DECL_COMMENTS—Comments in declarations
The total number of comments that are outside executable code. This metric considers a sequence of line comments to be a single comment. This is a companion metric to EXEC_COMMENTS that counts the number of comments within executable code.
   DOC_COMMENT—Number of javadoc comment lines
The number of lines within javadoc comments, i.e., comments that start with /** and end with */. Javadoc comments that share lines with other text are excluded from this metric.
   ELOC—Effective lines of code
The number of effective code lines in the source file. This is computed using the formula:

ELOC=LOC-<number of lines containing only {, }, ( or )>.

EXEC_COMMENTS—Comments in executable code
The total number of comments that are within executable code. This metric considers a sequence of line comments to be a single comment. This is a companion metric to DECL_COMMENTS that counts the number of comments outside of executable code.
   EXITS—Procedure exits
The metric measures the total number of unique methods called by all code in the source file.
   FUNCTIONS—Number of function declarations
The number of method declarations in the source file.
   HALSTEAD_DIFFICULTY—Halstead program difficulty
This is one of the Halstead complexity metrics. It is a measure of the algorithmic complexity of the code, it is computed using the formula:

HALSTEAD_DIFFICULTY=(UNIQUE_OPERATORS/2)*(OPERANDS/UNIQUE_OPERANDS)

HALSTEAD_EFFORT—Halstead program effort
This is one of the Halstead complexity metrics. It is a measure of the effort required to create the code. It is computed using the formula:

HALSTEAD_EFFORT=HALSTEAD_DIFFICULTY*PROGRAM_VOLUME

INTERFACE_COMPLEXITY—Interface complexity
This metric is a measure of the complexity of the relationship between methods in this source file and the remainder of the project. It is computed using the formula:

INTERFACE_COMPLEXITY=PARAMS+EXITS

LINE_COMMENT—Number of line comments
The number of line comments, i.e., comments that start with // and continue to the end of the line. Line comments that share a line with other text are excluded from this metric.
   LINES—Number of lines
The number of lines in the source file. This includes the final line, even if that line is not terminated with a carriage return or line feed.
   LOC—Lines of code.
The number of code lines in the source file. This is computed using the formula:

LOC=LINES−LINE_COMMENT−BLOCK_COMMENT−DOC_COMMENT−WHITESPACE

LOGICAL_LINES—Number of statements
The number of statements in the source file. This is measured by counting the number of semicolons in the source file (excluding those within comments and string/character constants.)
   LOOPS—Number of loops
The number of loops in the source file. This is the combined total count of for, do and while loops.
   NEST_DEPTH—Maximum nesting depth
The maximum nesting depth of code in the source file. The nesting depth increases by one every time a new block is started and decreases by one every time a block ends.
   OPERANDS—Number of operands
The number of operands in the source file. In this context, an operand refers to any token that is a user-supplied name. These include class, field, variable and method names. In addition, every component of a dot-qualified package name counts as an operand. Every token in a source file is one of the following: a comment, whitespace, an operator or an operand.
   OPERATORS—Number of operators
The number of operators in the source file. In this context, an operator refers to any token that is not a comment, whitespace or a name. The idea behind the metric is that it counts how much overhead is imposed by the syntax of the programming language.
   PARAMS—Number of formal parameter declarations
The total number of parameters declared in all of the methods in the source file.
   PROGRAM_LENGTH—Halstead program length
This is one of the Halstead complexity metrics. It measures the total number of tokens in the source file, excluding whitespace and comments. It is computed using the formula

PROGRAM_LENGTH=OPERATORS+OPERANDS

PROGRAM_VOCAB—Halstead program vocabulary
This is one of the Halstead complexity metrics. It measures the total number of unique tokens in the source file, excluding whitespace and comments. It is computed using the formula:

PROGRAM_VOCAB=UNIQUE_OPERATORS+UNIQUE_OPERANDS

PROGRAM_VOLUME—Halstead program volume
This is one of the Halstead complexity metrics. It measures the information content of the source file. It is computed using the formula:

PROGRAM_VOLUME=PROGRAM_LENGTH*log 2(PROGRAM_VOCAB)

RETURNS—Number of return points from functions
The total number of return points from all of the methods within a source file. A return point is one of (1) an explicit return statement; (2) an explicit throw statement that is not handled by a catch block within the method; (3) a call to a method declared to throw checked exceptions that are not handled by a catch block within the method; or (4) the final statement of the method, if it is neither a throw nor a return statement.
   SIZE—Size of the source file in bytes
The size of the source file in bytes.
   UNIQUE_OPERANDS—Number of unique operands
The number of unique operands in the source file.
   UNIQUE_OPERATORS—Number of unique operators
The number of unique operators in the source file.
   WHITESPACE—Number of whitespace lines
The number of lines in the source file that are empty or contain only whitespace characters.

### CONCLUSION

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined, solely by the claims appended hereto and that the claims be interpreted as broadly as permitted by the prior art.

1. A method of generating a software quality index descriptive of quality of a given body of software code, the method comprising:
identifying, by analysis of the body of software code, fault-prone files in the body of software code;
constructing and training, by analysis of the body of software code, a model derived from analysis of the body of software code; and
generating, based on the model, an index score representative of the quality of the body of software code.

2. The method of claim 1 wherein the identifying of fault-prone files comprises:
reading details of each checkin between defined analysis start and end dates from a source code control system;
if the checkin details for a given file indicate a fault, such as by a comment containing a keyword indicating a fault, incrementing the fault count for each file modified by the checkin;
compiling, from the checkin details, a list of files with their corresponding fault counts;
sorting the files in descending order of the number of faults identified;
for each file, recording the cumulative number of faults identified;
determining the total number of faults defined by the cumulative number recorded against the last file in the list; and
reading down the list of files until a point in the list is reached at which the cumulative number of faults reaches a defined percentage of the total number of faults, wherein the files down to that point in the list are defined to be the fault-prone files.

3. The method of claim 1 wherein the constructing and training of a model comprises:
obtaining source code for the start date of a defined analysis range;
computing source code metric values and static analysis violation counts for all files in the defined analysis range;
identifying the fault prone files within the analysis range;
constructing a naive Bayesian model using two categories, fault-prone and non-fault-prone;
modeling the static analysis violation counts with a Poisson distribution using the sample mean;
modeling the source metrics using the Normal distribution using the sample mean and variance; and
if more than one training project is available, testing by training on all but one of the training projects and measuring the classification error on the remaining one.

4. The method of claim 1 wherein the generating of an index score representative of the quality of the body of software code comprises:
computing source code metric values and static analysis violation counts for all files in the body of software code;
submitting each file individually to the naive Bayesian model to compute a predicted probability that the file is fault-prone;
converting the probability to an index score using the formula:
score=10(1−prob(fault-prone));
computing an index score for a directory of source files by taking the arithmetic mean (simple average) of the scores of all files in the directory and any subdirectories; and
computing an index score for the body of software code by taking the arithmetic mean of the scores of all files in the body of software code.

5. In a software code development system, a subsystem for generating a software quality index descriptive of quality of a given body of software code, the subsystem comprising:
means for identifying, by analysis of the body of software code, fault-prone files in the body of software code;
means for constructing and training, by analysis of the body of software code, a model derived from analysis of the body of software code; and
means for generating, based on the model, an index score representative of the quality of the body of software code.

6. A computer program code product for use in a computer in a software code development system, the computer program code product being operable to enable the computer to generate a software quality index descriptive of quality of a given body of software code under development, the computer program code product comprising computer-executable program code stored on a computer-readable medium, the computer program code further comprising:
first computer program code means stored on the computer-readable medium and executable by the computer to enable the computer to identify, by analysis of the body of software code under development, fault-prone files in the body of software code under development;
second computer program code means stored on the computer-readable medium and executable by the computer to enable the computer to construct and train, by analysis of the body of software code under development, a model derived from analysis of the body of software code under development; and
third computer program code means stored on the computer-readable medium and executable by the computer to enable the computer to generate, based on the model, an index score representative of the quality of the body of software code under development.

7. The computer program code product of claim 6 wherein the identifying of fault-prone files comprises:
reading details of each checkin between defined analysis start and end dates from a source code control system;
if the checkin details for a given file indicate a fault, such as by a comment containing a keyword indicating a fault, incrementing the fault count for each file modified by the checkin;
compiling, from the checkin details, a list of files with their corresponding fault counts;
sorting the files in descending order of the number of faults identified;
for each file, recording the cumulative number of faults identified;
determining the total number of faults defined by the cumulative number recorded against the last file in the list; and
reading down the list of files until a point in the list is reached at which the cumulative number of faults reaches a defined percentage of the total number of faults, wherein the files down to that point in the list are defined to be the fault-prone files.

8. The computer program code product of claim 6 wherein the constructing and training of a model comprises:
obtaining source code for the start date of a defined analysis range;
computing source code metric values and static analysis violation counts for all files in the defined analysis range;
identifying the fault prone files within the analysis range;
constructing a naive Bayesian model using two categories, fault-prone and non-fault-prone;
modeling the static analysis violation counts with a Poisson distribution using the sample mean;
modeling the source metrics using the Normal distribution using the sample mean and variance; and
if more than one training project is available, testing by training on all but one of the training projects and measuring the classification error on the remaining one.

9. The computer program code product of claim 6 wherein the generating of an index score representative of the quality of the body of software code comprises:
computing source code metric values and static analysis violation counts for all files in the body of software code;
submitting each file individually to the naive Bayesian model to compute a predicted probability that the file is fault-prone;
converting the probability to an index score using the formula:
score=10(1−prob(fault-prone));
computing an index score for a directory of source files by taking the arithmetic mean (simple average) of the scores of all files in the directory and any subdirectories; and
computing an index score for the body of software code by taking the arithmetic mean of the scores of all files in the body of software code.
